(19) United States
(12) Patent Application Publication
(10) Pub. No.: US 2010/0241699 A1
(43) Pub. Date: Sep. 23, 2010

(54) Device-Based Control System

(76) Inventors: Sivasubramanian MUTHUKUMARASAMY, Santa Clara, CA (US); Thirumalai ARUNACHALAM, Santa Clara, CA (US); Balamurugan KRISHNAN, Santa Clara, CA (US)

Correspondence Address: COURTNEY STANIFORD & GREGORY LLP, 10001 N. De Anza Blvd., Suite 300, Cupertino, CA, 95014, US

(21) Appl. No.: 12/728,670

(22) Filed: Mar. 22, 2010

Related U.S. Application Data
(60) Provisional application No. 61/162,245, filed on Mar. 20, 2009.
(60) Provisional application No. 61/262,926, filed on Nov. 20, 2009.

(51) Int. Cl. G06F 15/16; G06F 15/18

(52) U.S. Cl. 709/203; 706/12

(57) ABSTRACT

A Device-Based Control System (DBCS) enables a device-agnostic and source-agnostic entertainment experience through use of an internet-enabled device (IED). The IED includes a media management application for navigating through media or entertainment content, controlling media devices according to a type of media content selected by the user, and sharing media experiences via social networks. The IED includes smartphones, tablet computers, and other internet-enabled processor-based devices. The DBCS leverages the internet access of the IED to enable search and discovery of all available media content. A content recommendation system (CRS) coupled to the media management application learns media preferences from user behavior, generates from numerous disparate media sources media choices corresponding to the media preferences, and presents the media choices on the IED.

### RELATED APPLICATIONS

This application claims the benefit of U.S. patent application Ser. No. 61/162,245, filed Mar. 20, 2009.

This application claims the benefit of U.S. patent application Ser. No. 61/262,926, filed Nov. 20, 2009.

### TECHNICAL FIELD

The embodiments described herein relate generally to control of electronic media devices and content. More particularly, the embodiments described herein relate to use of an internet-enabled device to control navigation through media or entertainment content and control media devices or components.

### BACKGROUND

Consumers have two levels of complexity to deal with in their premises (e.g., homes, offices, etc.). A first complexity deals with managing and controlling various electronic components or equipment in the premises (e.g., audio components, video components, digital video recorders (DVRs), digital video players, etc.). The conventional solution to this problem has been the universal remote that allows a consumer to control more than one component with a single remote.

A second complexity is that the consumer currently has no way to interactively research/browse through the plethora of content choices that are available for them to watch and/or listen to from numerous sources at any particular moment. Consumers of content are faced with the ever increasing dilemma of finding content to watch that matches their desires and needs. Given that most consumers now have access to a plethora of channels, the current approach of using an Electronic Program Guide (EPG) to search for TV content is not a satisfactory approach and most consumers confine their viewing to a limited subset of channels. When content from IPTV and other internet sources are included this approach fails completely. Furthermore, the use of search assumes that the user knows what they are searching for, and works well under that assumption. However, in many, if not most, circumstances the user does not have a specific piece of content that they wish to search for and watch.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of the Device-Based Control System (DBCS), under an embodiment.

FIG. 2 is a first example screenshot presented on the IED showing content-based navigation, under an embodiment.

FIG. 3 is a second example screenshot presented on the IED showing content-based navigation, under an embodiment.

FIG. 4 is an example screenshot presented on the IED showing context-based and gesture-based media device control, under an embodiment.

FIG. 5 is a table that is a first example mapping (“Eyes on the TV, Until Viewer Presses Search Button”) of context based on actions mapped to user actions, under an embodiment.

FIG. 6 is a table that is a second example mapping (“Eyes on the Device”) of context based on actions mapped to user actions, under an embodiment.

FIG. 7 is an example screenshot presented on the IED showing media content research using the IED, under an embodiment.

FIG. 8 shows the form factor of the zHub, under an embodiment.

FIG. 9 shows the form factor of the zNode, under an embodiment.

FIG. 10 shows the form factor of the zNode base with three (3) different tops, under an embodiment.

FIG. 11 is a block diagram for generating a custom program feed for the Content Index Database (CID), under an embodiment.

FIG. 12 is a block diagram for transferring codes to and from the IR code database (UES format), under an embodiment.

FIG. 13 is a block diagram for premise component configuration setup, under an embodiment.

FIG. 14 is a block diagram of a logical representation of a media device in a premise component configuration setup, under an embodiment.

FIG. 15 (collectively 15/1, 15/2 and 15/3) is a flow diagram for specifying and configuring the DBCS to interact with media components at a premise, under an embodiment.

FIG. 16 is a block diagram for operation of the Component Recommendation System (CRS), under an embodiment.

FIG. 17 is a block diagram of a social network formed among DBCS users, under an embodiment.

FIG. 18 is a block diagram of a home network comprising the IED along with a computer hosting the RCIBS, under an embodiment.

FIG. 19 is a table of commands generated by the IED and the resulting action or operation by the RCIBS in response to the command, under an embodiment.

### DETAILED DESCRIPTION

A Device-Based Control System (DBCS) is described that enables consumers, through the use of an internet-enabled device (IED), to navigate through media or entertainment content, control media components or equipment to watch and/or listen to media content, and share their media experiences with an internet community or social network. The internet-enabled devices of an embodiment include any processor-based device with internet connectivity, a screen, and a means to navigate controls on the screen, for example, smartphones, tablet computers, touch-enabled devices (e.g., iPhone®, iPod®, iPad®, etc.), personal computers (PCs), digital photo frames, and other internet-enabled processor-based client or remote devices. The DBCS leverages the internet access of the IEDs to enable search and discovery of all available media content.

The DBCS overcomes the complexities described above to provide consumers with direct access to media content choices that are available for them in a user-friendly way on IEDs. Thus, the DBCS, using a combination of premise hardware, a software system, and/or internet access, allows consumers to select and control media content via their internet-enabled device. The DBCS changes the way consumers select media and how they control that media across their entertainment components or devices and, as such, enables a device-agnostic and source-agnostic entertainment experience.

Although the detailed description herein contains many specifics for the purposes of illustration, anyone of ordinary skill in the art will appreciate that many variations and alterations to the following details are within the scope of the embodiments described herein. Thus, the following illustrative embodiments are set forth without any loss of generality to, and without imposing limitations upon, the claimed invention.

The following terms can have the following general meanings as they are used herein, but can also have meanings attributed to them by one skilled in the art.

“Touch-handheld” or “Touch-Enabled Device” is any device that has a touch screen and can be interacted with in a mobile form. For example, devices like the iPhone®, iPod®, iPad®, and/or Nexus® Phone are touch-handheld devices.

“Content Source” is a source from which a specific piece of content is made available (e.g., broadcast, cable, over the air, online, digital video disk (DVD), video on demand (VOD), etc.).

“Input” refers to various input ports on a component such as a television (TV), audio/video (AV) receiver, and the like (e.g., HDMI1 port, Component 1 port, etc.).

“zHub” is a hardware component that converts Ethernet signals to radio frequency (RF) signals.

“zNode” is a hardware component that converts RF signals to infrared (IR) signals.

“Cloud” is an Internet server-based software and data.

“Device/Equipment” is entertainment components or devices such as TV, DVD player, Apple TV device, to name a few.

“Router” is an Internet switch that is coupled or connected to an internet cable or digital subscriber link (DSL) modem and enables a home network that is shared by one or more internet protocol (IP)-based devices (e.g., personal computer (PC), WiFi devices, etc.) in the home.

“IR Code” is an infrared code used to control or perform a specific action on a component or piece of equipment.

“RF” is a radio frequency signal used to wirelessly communicate between the zHub and the zNode.

“Program Guide” is a collection of metadata corresponding to available media content (e.g., TV programs, audio programs, etc.). Examples include, but are not limited to, electronic TV guides or electronic program guides, for instance.

“Online Media” is Internet-based media content.

“Serendipity” or “Content Recommendation System (CRS)” is the Zelfy software algorithm system that provides content or other program recommendations based on user behavior.

“Gesture” is a touch-based and/or movement-based interaction with an interface device or an interface of a device (e.g., swipe right, swipe left, tap, move right, move left, shake, etc.).

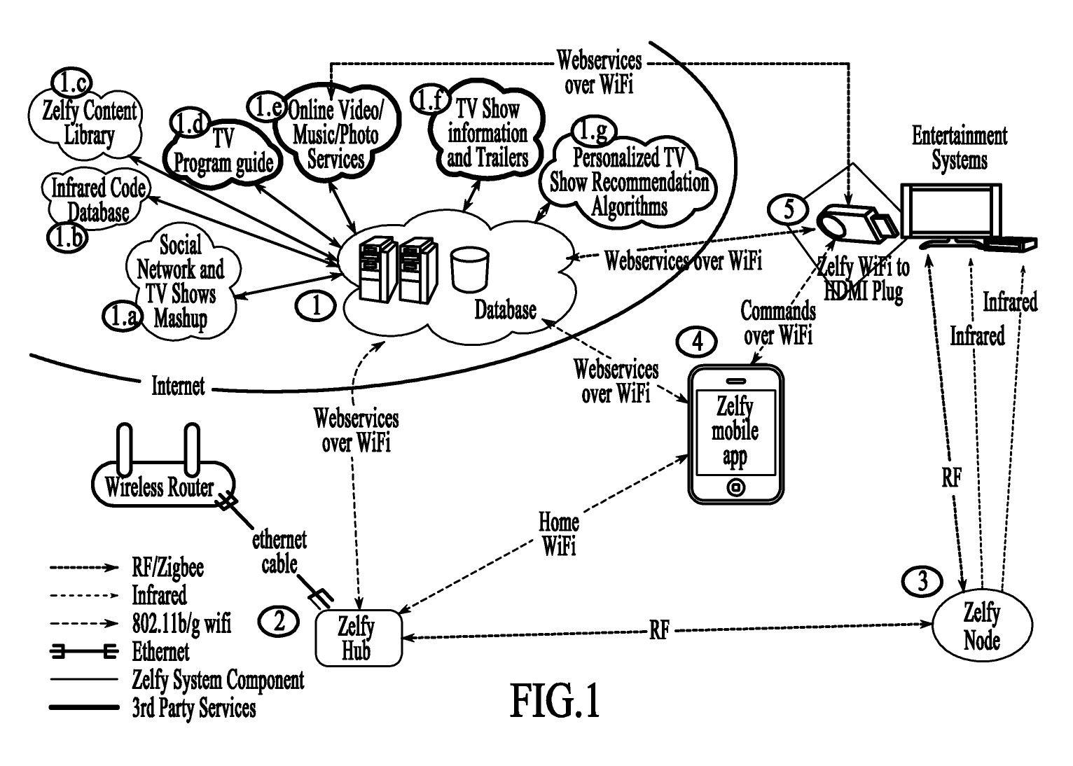

FIG. 1 is a block diagram of the Device-Based Control System (DBCS), under an embodiment. The DBCS of an embodiment comprises a hub 2, referred to herein as the zHub 2, a node 3, referred to herein as the zNode 3, and an DBCS application or software that executes on a processor of the internet-enabled device (IED) 4 with which the consumer interacts. The zHub 2 comprises a hardware component that receives signals or commands from the IED 4 via a local or premise network (e.g., router, WiFi, etc.) and translates the commands to RF signals. The zNode 3 comprises a hardware component that receives RF signals from the zHub 2 and translates the RF signals to a protocol (e.g. Infrared) interpretable by the media components. The zHub 2 and zNodes 3 present at a premise can be referred to herein as a media control network, but are not so limited. The DBCS application that runs or is hosted on the IED 4 can be referred to herein as a media management application, but is not so limited.

The DBCS comprises a Content Index Database (CID) 1C, also referred to as content library 1C, hosted on an internet server 1, which manages electronic program guide information. The DBCS comprises a device map and infrared database 1B, hosted on the internet server 1, used in the management of media components at the premise. The DBCS comprises a recommendation algorithm 1G, hosted on an internet server 1, which suggests media content to a consumer based on consumer behavior. The recommendation algorithm can be referred to herein as a Content Recommendation System (CRS), but is not so limited. The DBCS comprises or forms a social platform 1A that manages the consumer's social experience around media content. The DBCS comprises a zHDStick that streams internet content over WiFi to High Definition television (HDTV). The DBCS comprises a zSky software agent that helps manage online media viewing on TV; the zSky agent can be hosted (e.g., preinstalled) on the zHDStick, or can be independently installed on a media PC, but the embodiment is not so limited. The DBCS also comprises a TV program guide 1D, online video/music/photo services 1E, and/or TV show information and trailers 1F. The components of the DBCS are described in detail below.

The DBCS software or application executes on a processor of the IED with which the consumer interacts. When the consumer uses the IED, he interacts primarily with the DBCS software to manage his home entertainment experience.

The DBCS software offers, through content-based navigation, content choices as its primary form of interface, where the content choices are tailored to an individual consumer's preference. The content choices are categorized using easy to understand genres that the consumer can quickly browse through to select content. The content choices are aggregated from a multitude of sources, for example, subscription media, broadcast media, cable, DVR, VOD and internet media to which the consumer has access.

Generally, the DBCS is a system comprising a media control network coupled to the internet via a local network of a premise. The DBCS comprises a media management application running on an internet-enabled device (IED) and controlling media devices at the premise via the media control network. The DBCS comprises a Content Recommendation System (CRS) coupled to the media management application, wherein the CRS learns media preferences from user behavior, generates from a plurality of disparate media sources media choices corresponding to the media preferences, and presents the media choices on the IED, wherein the media management application automatically controls delivery of selected media content and selects and controls the media devices that deliver the selected media content according to a media type of the selected media content.

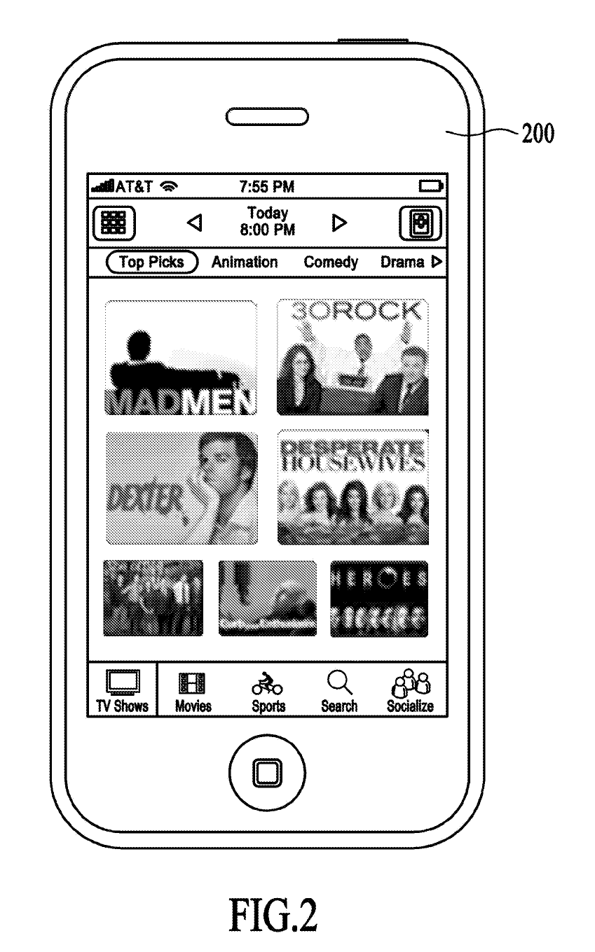

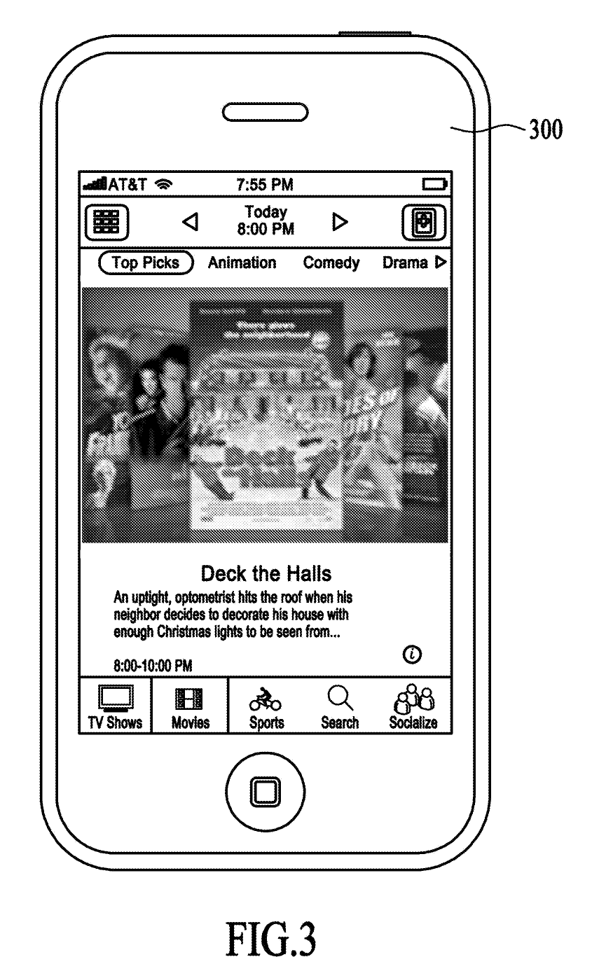

FIG. 2 is a first example screenshot 200 showing content-based navigation, under an embodiment. This example screenshot 200 includes “Top Pick” recommendations (in the category of “TV Shows”) generated and presented by the CRS via the IED. FIG. 3 is a second example screenshot 300 showing content-based navigation, under an embodiment. This example screenshot 300 includes “Top Pick” recommendations (in the category of “Movies”) generated and presented by the CRS via the IED. These examples 200/300 are shown as examples on the iPhone®, from Apple®, Inc., but the embodiments herein are not limited to the iPhone® and can be used with any processor-based IED. The DBCS software causes personalized content choices to be presented on a display of the IED in an image format categorized by content. The content is customized for the specific user depending on what media services (e.g., cable, broadcast, etc.) the user has in the premise. The content choices spread across numerous sources and devices. Depending on time of the day the user accesses the DBCS software, the content changes depending on content availability at that time of the day.

Once the content is chosen, the DBCS software enables, via the IED, contextual gesture-based control of media components (e.g., volume selection, channel selection, pause/play, etc.) by the consumer. The media component control is enabled through gestures that enable the consumer to access and control media and components without having to look at the IED.

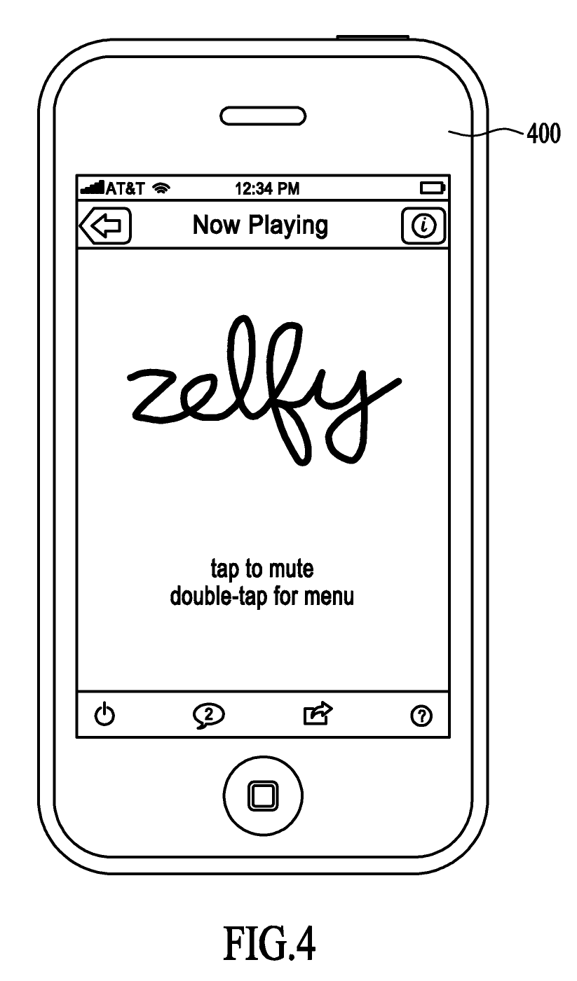

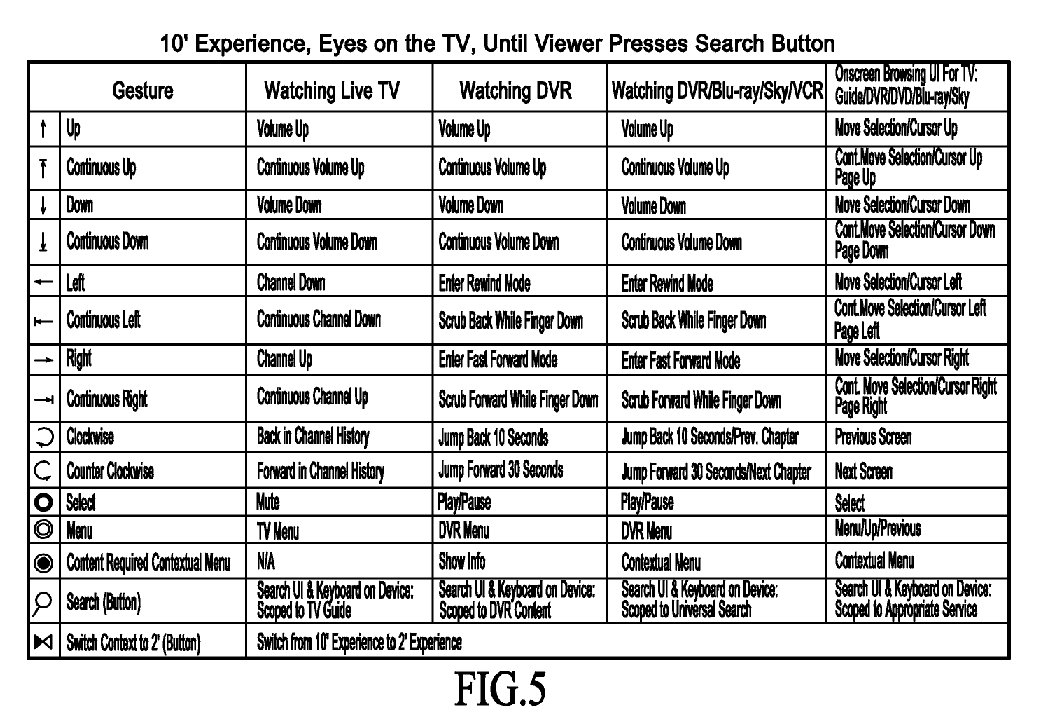

FIG. 4 is an example screenshot 400 showing context-based and gesture-based media device control, under an embodiment. This example 400 is shown as an example on the iPhone®, from Apple®, Inc., but the embodiments herein are not limited to the iPhone® and can be used with any processor-based device. The control of media content and devices are enabled through gestures made via the IED. For example when watching DVD players, a single tap on the IED 400 controls the pause function of the DVD, and tapping again on the IED 400 controls the resume play function of the DVD. Similarly, swiping right on the IED screen interface controls the skip function to skip the content to a subsequent chapter, and swiping left controls the skip function to skip the content to a previous chapter. Swiping up and down on the IED screen interface controls the volume on the appropriate media device (e.g., TV, AV Receiver, etc.). Moreover, gesturing right with the IED can control the skip function to skip the content to a subsequent chapter, and gesturing left can control the skip function to skip the content to a previous chapter. Gesturing up and down with the IED can control the volume on the appropriate media device (e.g., TV, AV Receiver, etc.).

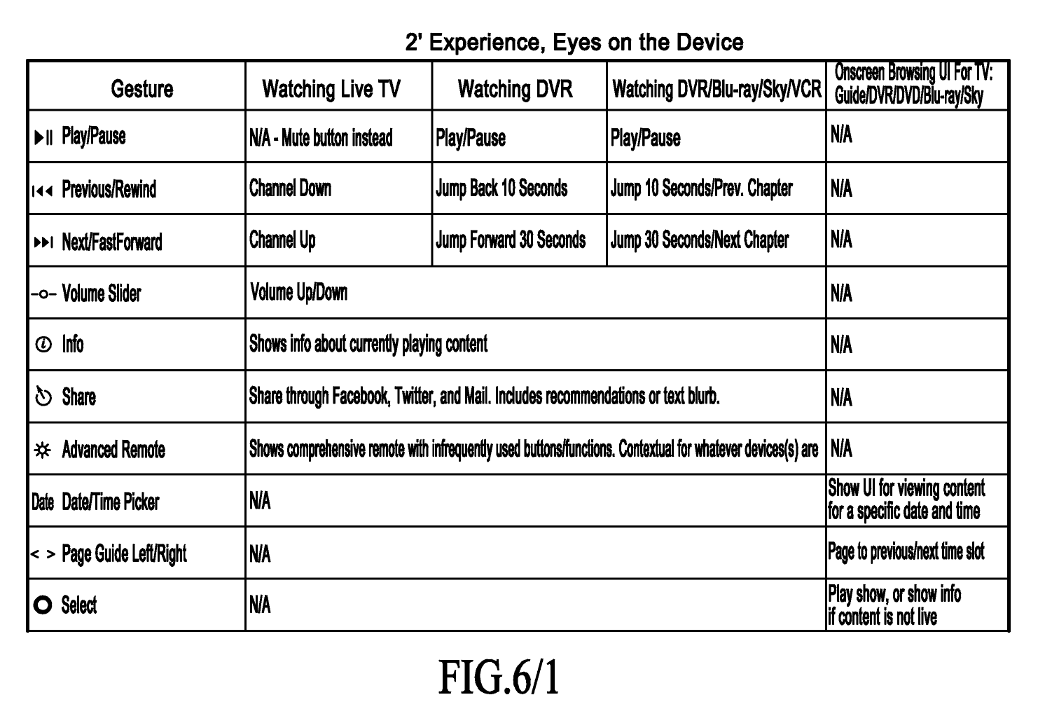

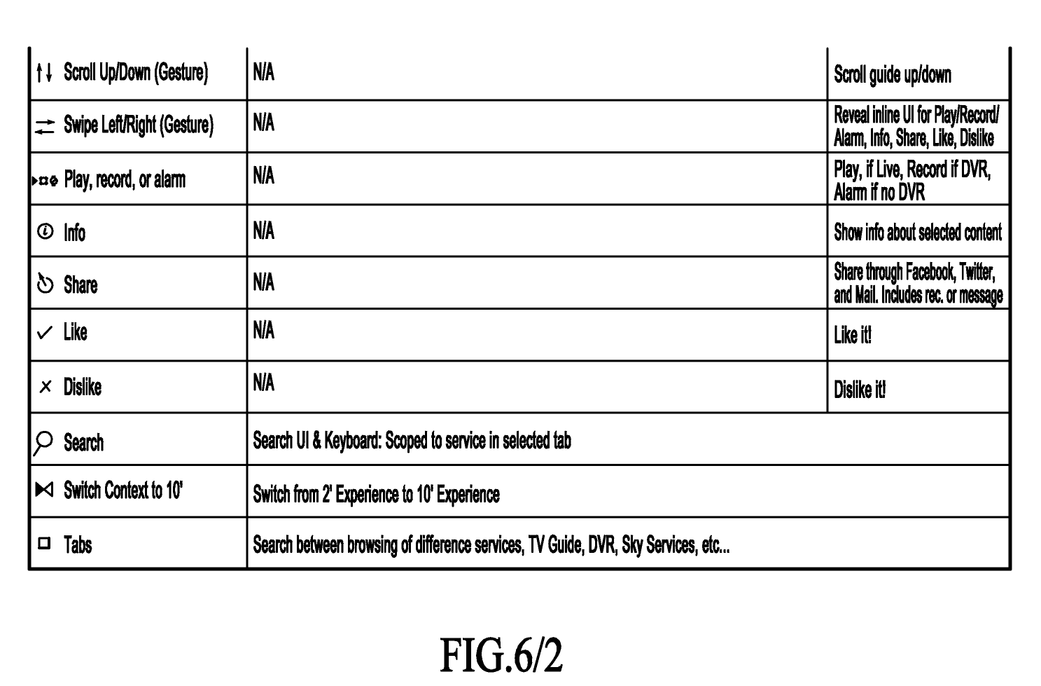

The gestures and touch actions of an embodiment control functions based on the context of the media currently being played. The gestures and touch actions can be changed dynamically, for example, from the Internet servers, but are not so limited. FIG. 5 is a table that is a first example mapping (“Eyes on the TV, Until Viewer Presses Search Button”) of context based on actions mapped to user actions, under an embodiment. FIG. 6 is a table that is a second example mapping (“Eyes on the Device”) of context based on actions mapped to user actions, under an embodiment.

The DBCS software enables a consumer to research media choices. Before committing to specific media content, the consumer can use the IED to perform research on the choice using. For example, the consumer can locate detailed descriptions of the media content, details about the plots of a show and collective opinions of others who have previously viewed the content.

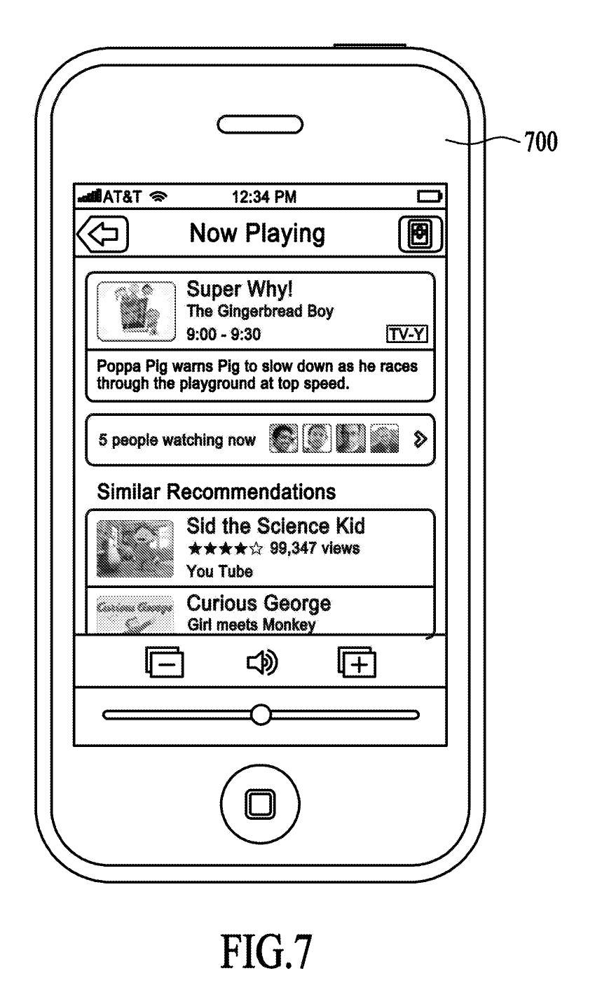

FIG. 7 is an example screenshot 700 showing media content research using the IED, under an embodiment. This example 700 is shown as an example for the iPhone®, from Apple®, Inc., but the embodiments herein are not limited to the iPhone® and can be used with any processor-based device. The consumer can use the IED to gather information about media content, for example, a detailed description of program content can be viewed from the IED, or the consumer can research via the IED similar content available from other sources. Additionally, this example screenshot shows the consumer the identity of others who are watching the same show (“5 people watching now”) and enables that consumer to share, or socialize, his entertainment experience with his friends. The consumer can also see what his social network friends are watching, and he can find out who else is watching the same show or a similar show to the one he is viewing. Thus the DBCS enables friends to assemble and chat, express or post comments, and/or rate specific media content.

While watching a specific show, the consumers can share their experience with others over the Internet through operation of the DBCS software. A consumer can share with their friends on social networks. Furthermore, they can publish what they are watching and chat with their friends to find out more about the show or discuss the show. All these operations can be performed via the IED from where the user chose the content.

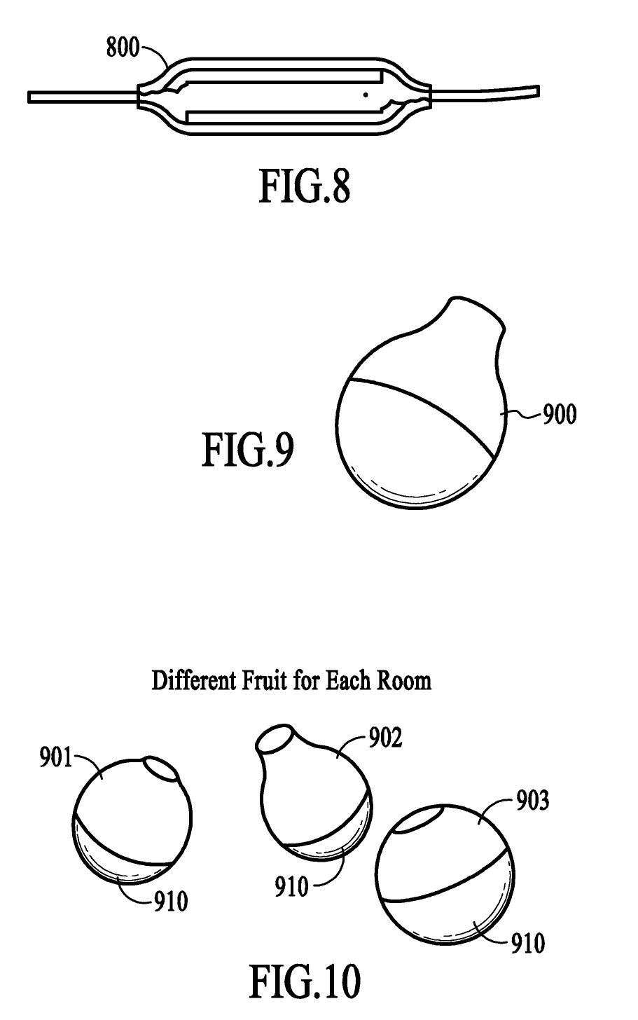

The zHub is a device that couples or connects on a first end to a power outlet (e.g., alternating current (AC) power) and couples or connects on a second end to a router or other network switch in the host premise. FIG. 8 shows the form factor 800 of the zHub, under an embodiment. The zHub, when coupled or connected to the router, is a participating device in the premise network and, as such, can access the Internet or other network via the router. The zHub, by virtue of being tethered to the premise network, is available on the premise network to be discovered and coupled to by the IED. The zHub publishes its IP Address via UPNP packets, and this enables the IED to discover or identify the zHub and form a coupling or connection to the zHub. Once the IED discovers a zHub in the network, it associates with the zHub.

When the IED sends a command, the zHub receives the command from the IED and resolves the command into a specific instruction directed at a specific zNode in the house. As such, the zHub resolves or maps the command to a specific IR code to be sent to a specific zNode via an RF signal. The zHub can cache IR codes or other data that may be used to control media devices. If the appropriate IR code is not available in the cache, the zHub looks up the code (e.g., from the internet server) as the zHub is always connected to the internet via the premise router. There may be more than one zNode on a premise and, if so, the zHub manages all registered zNodes on the premise. Furthermore, a single zHub can simultaneously interact with more than one zNode. As an example, when a user selects content that is on channel 324 to be displayed on the living room TV, the zHub translates the command into a specific RF signal directed at the zNode in the living room.

The zNode is a device that can be placed on a structure (e.g., piece of furniture, shelf, etc.) in the premise in a position from which it has a reasonable line of sight to the media components. FIG. 9 shows the form factor 900 of the zNode, under an embodiment. The primary function of each zNode is to receive commands from the zHub and translate the commands for control of media devices via the media device control protocol. The zNode of an embodiment is battery-operated, but is not so limited. The zNode receives commands from the zHub via RF signals and translates the commands to IR signals. Generally, the IR code data itself is cached in the zNode, but if not cached, the zHub is aware and transmits the IR code as a part of the request. Using information of the received command, the zNode broadcasts a corresponding IR signal to control the media devices.

In addition to emitting IR signals, the zNode also receives IR signals. This capability enables a consumer to learn/teach codes into the DBCS that are not available as a part of the DBCS IR database. The zNode also monitors battery performance and reports the battery information to the zHub; the zHub reports the batter information back to the IED (e.g., on request). The zNode of an embodiment can receive and process analog signals and, thus, can receive information of other premise parameter sensors (e.g., room temperature, sound levels, compass, accelerometer, etc.) that can be used as media device control parameters.

One zNode is used to correspond to each TV at the consumer's premise. All zNodes of the premise are registered with the zHub. The tops of the different zNode “fruit” are exchangeable with the base being the same, and this enables consumers to mix and match any fruit if they are purchasing multiple fruit for their different media systems. FIG. 10 shows the form factor of the zNode base 910 with three (3) different tops 901/902/903, under an embodiment.

The DBCS comprises a Content Index Database (CID), as described above with reference to FIG. 1. The CID of an embodiment, also referred to as the program database, is hosted on an internet server and manages electronic program guide information, but is not so limited. The CID comprises all program information related to premise entertainment for a specific user. As an example, the CID comprises the data for an electronic TV Guide.

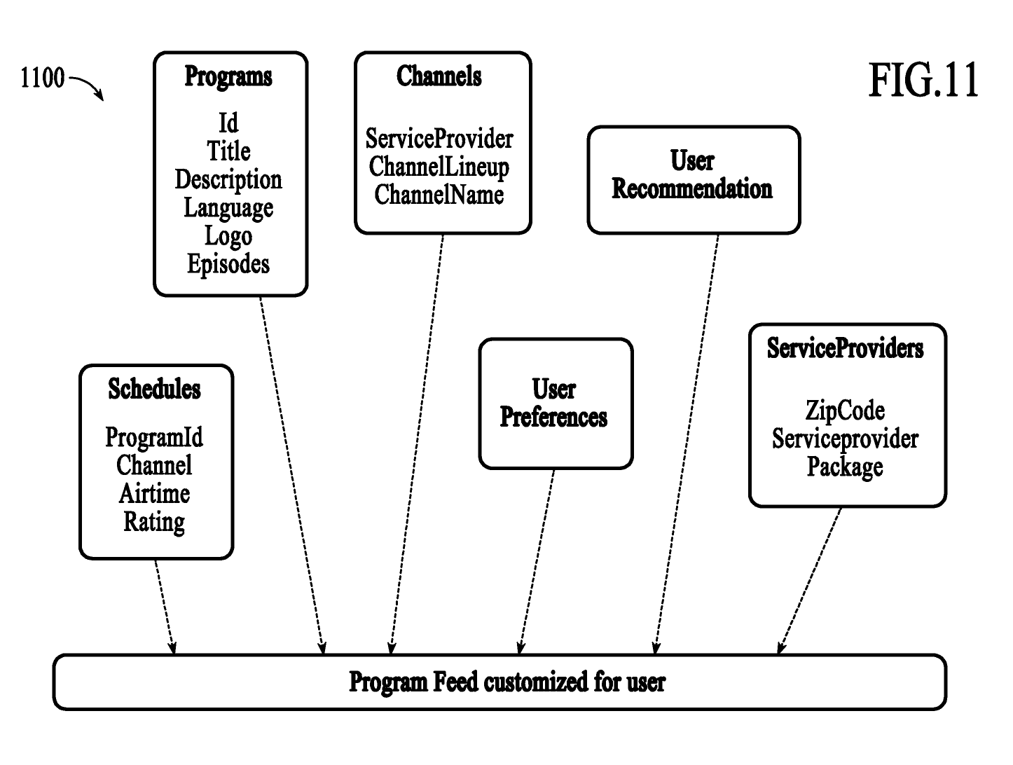

FIG. 11 is a block diagram 1100 for generating a custom program feed for the CID, under an embodiment. The CID receives a periodic feed of content metadata from different systems (e.g., TV Guide data (received from Tribune Media Services), DVR, internet media content, VOD, etc.), and aggregates the content index (metadata) from these sources. This data is received in a source-proprietary format, and includes data of schedules, programs, channels, service providers, user recommendations, and user preferences, to name a few. The DBCS includes a universal data loader (e.g., an XML-based data loader) that can load any media metadata from any source; the DBCS achieves this based on a data format dictionary for each source. The DBCS reformats the received data to a format that is easily browseable and searchable. The DBCS recommendation system uses the CID to generate tailored content for each consumer.

The CID is refreshed periodically (e.g., every night, every twelve hours, every hour, etc.) using a periodic feed of content metadata received from different systems (e.g., TV Guide data is received from Tribune Media Services, DVR, internet media content, VOD, etc.). In processing the data, the received content metadata is placed in a staging area and checked. The large volume of metadata is processed using a rules-based engine that automatically loads the data and classifies it into DBCS genres. The incoming metadata corresponding to the content is automatically classified into a smaller set of genre that the user can manage. This auto-classification is performed using a cross-reference between source genres and destination genres. The processing of an embodiment automatically re-links the images that serve as a primary interface to the users.

The periodic process or refreshing the CID includes the use of crawlers that crawl media sites (e.g., video, music, images, etc.). The crawlers index content metadata (URLs) from a multitude of media sites, and data resulting from crawling activity is stored at the CID. Because the DBCS of an embodiment is directed at TV and movie content, the crawler uses the TMS data as a basic dataset such that the TMS constrains the crawler to stay within this known or pre-defined realm, but the embodiment is not so limited. The CID of an embodiment, however, extends to any media from any source. Similarly, the Serendipity Recommendation System also functions with any type of media from any source.

The DBCS comprises a device map and infrared database, hosted on the internet server, used in the management of media components at the premise, as described above with reference to FIG. 1. The device map and infrared database of an embodiment includes a device map database and an infrared database, as described below.

The infrared database comprises the infrared codes needed to control the media components in a premise. The DBCS stores and maintains the infrared database on one or more Internet servers. The control codes necessary for a specific premise are written to the premise zHub on demand during initial system configuration. The infrared codes are maintained in a DBCS universal control format, referred to herein as the UES Format. As new consumer electronic devices come into the market their respective codes are made available in this database so that the codes are available to the consumers on demand.

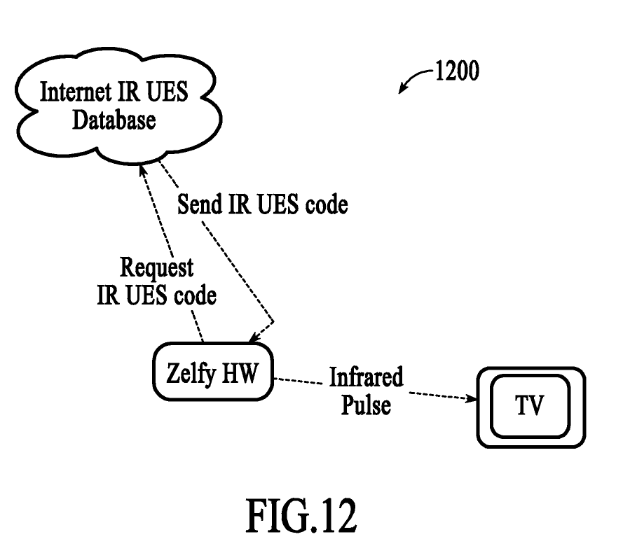

The UES Format is an DBCS-proprietary format for storing infrared codes in raw format in the database. Unlike conventional solutions that store IR codes in a compressed format, the UES Format stores the frequency and Mark-Space timings of the IR pulses as a series of numbers. This enables storage and delivery of the codes via an internet connection or coupling. The storage and distribution of individual infrared codes is through a webservice-based request-response architecture. The Infrared codes are also cached on the zNode and/or zHub. FIG. 12 is a block diagram 1200 for transferring codes to and from the UES database, under an embodiment.

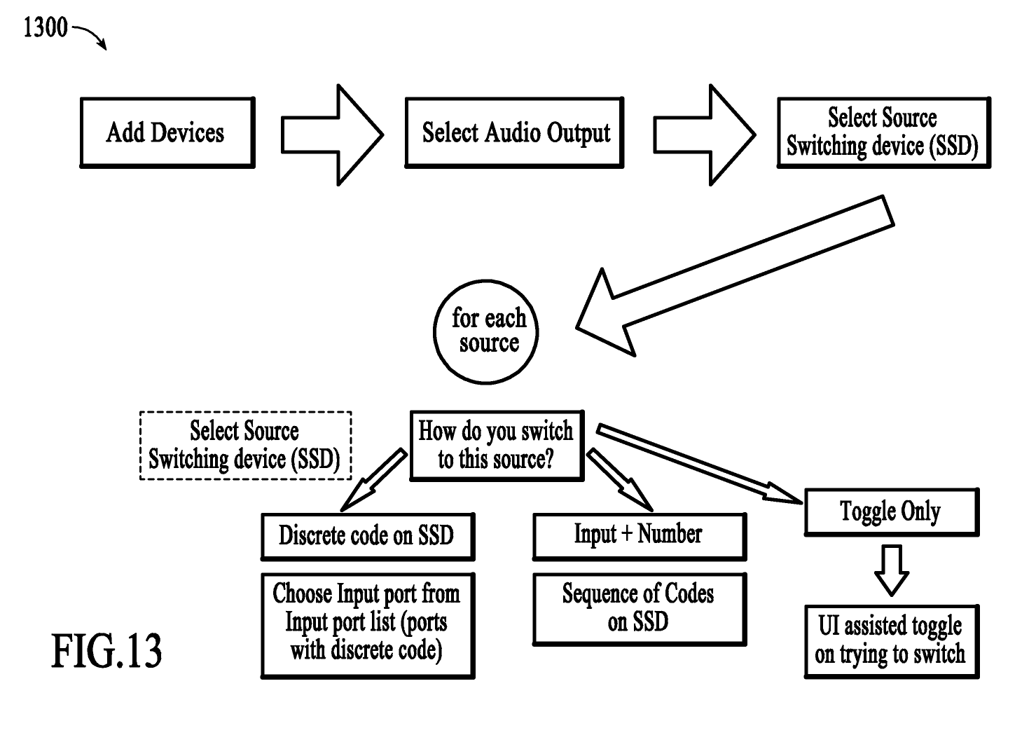

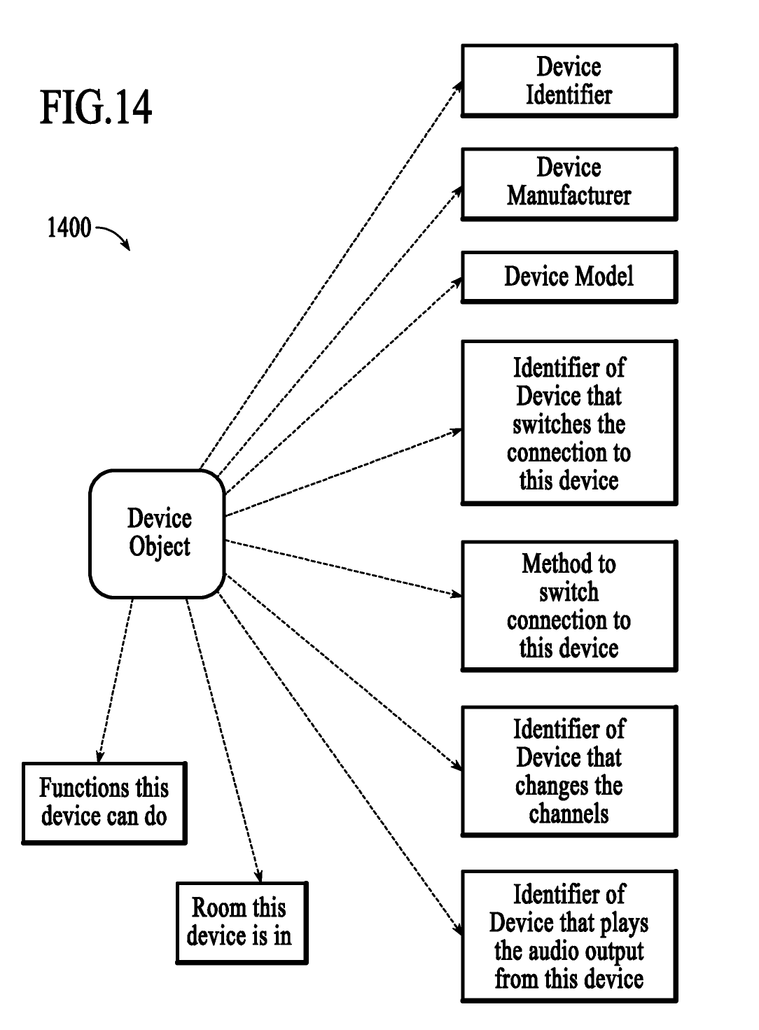

In order to provide a device-agnostic entertainment experience, the device map database of an embodiment comprises a logical representation of each of the devices at a consumer's premise and the configuration in which they are coupled or connected. The media component configuration of a premise/user is abstracted by core functions (e.g., audio output devices, video output devices, video content sources, audio output sources, intermediate switchers, etc.) and the various component relationships, for example, and is logically represented as relationships between these participants. This enables the DBCS to scale across various consumer configurations at a premise. FIG. 13 is a block diagram 1300 for premise component configuration setup, under an embodiment. FIG. 14 is a block diagram 1400 of a logical representation of a media device in a premise component configuration setup, under an embodiment.

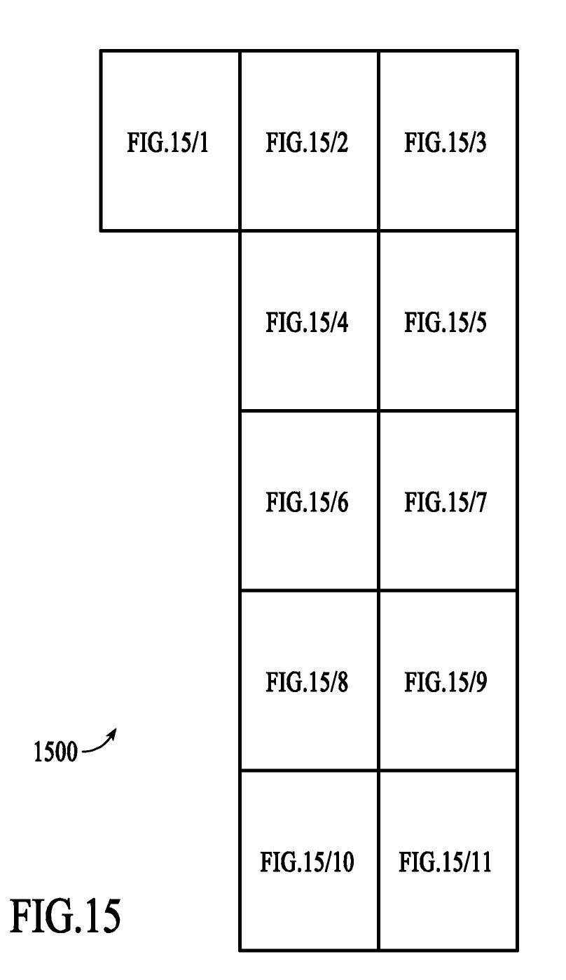

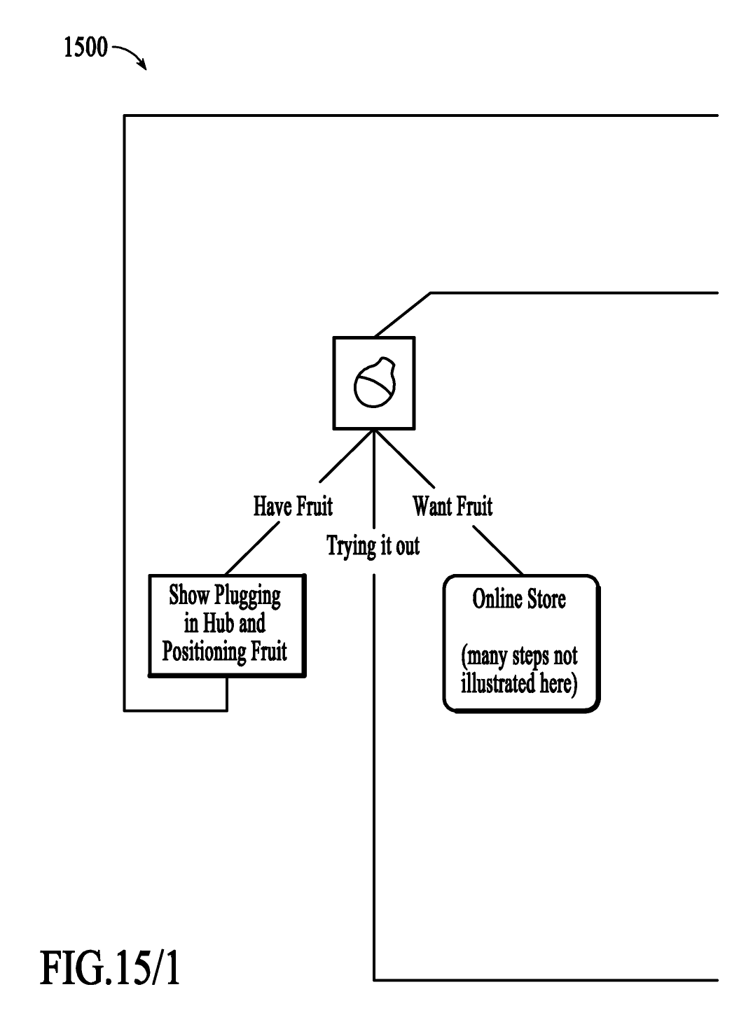

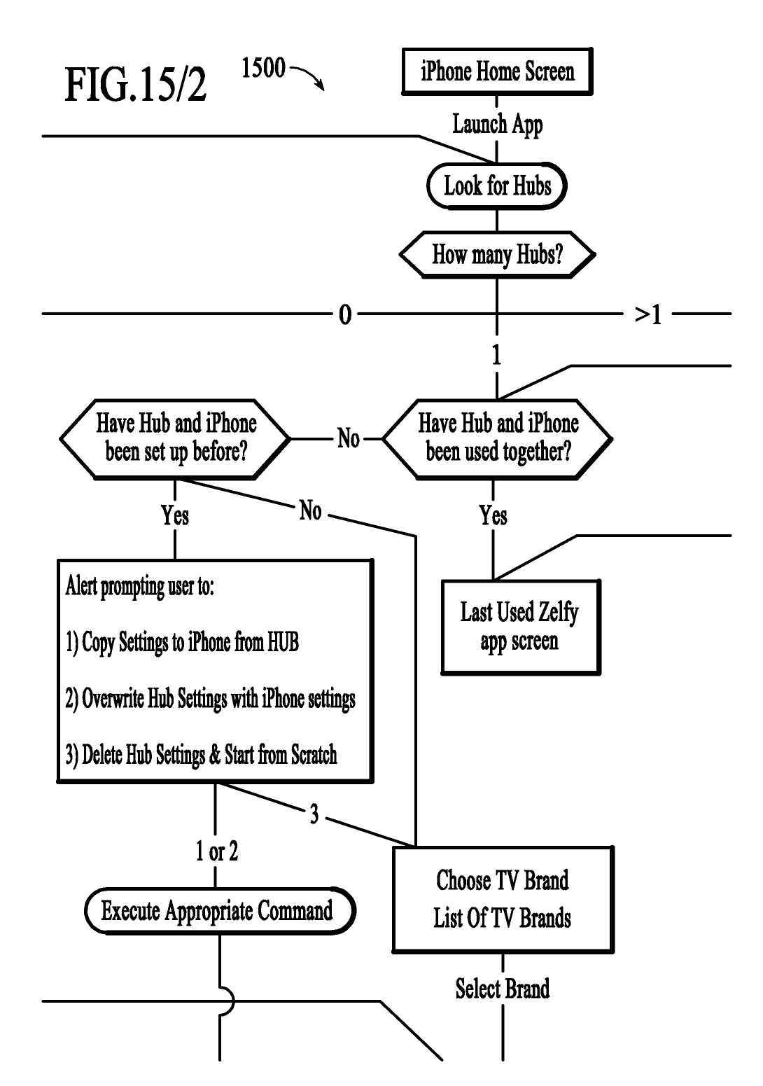

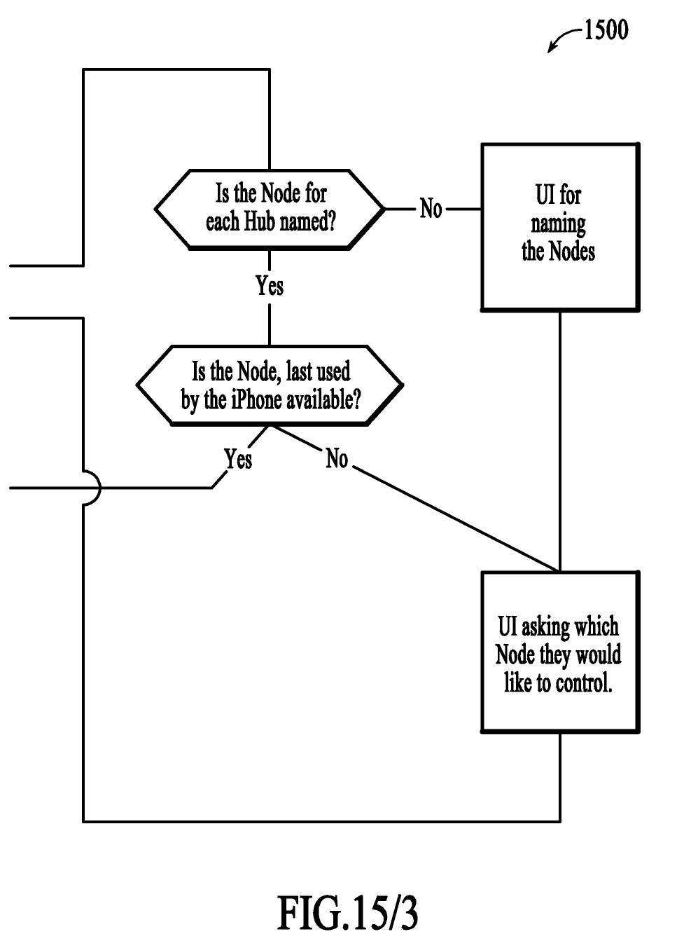

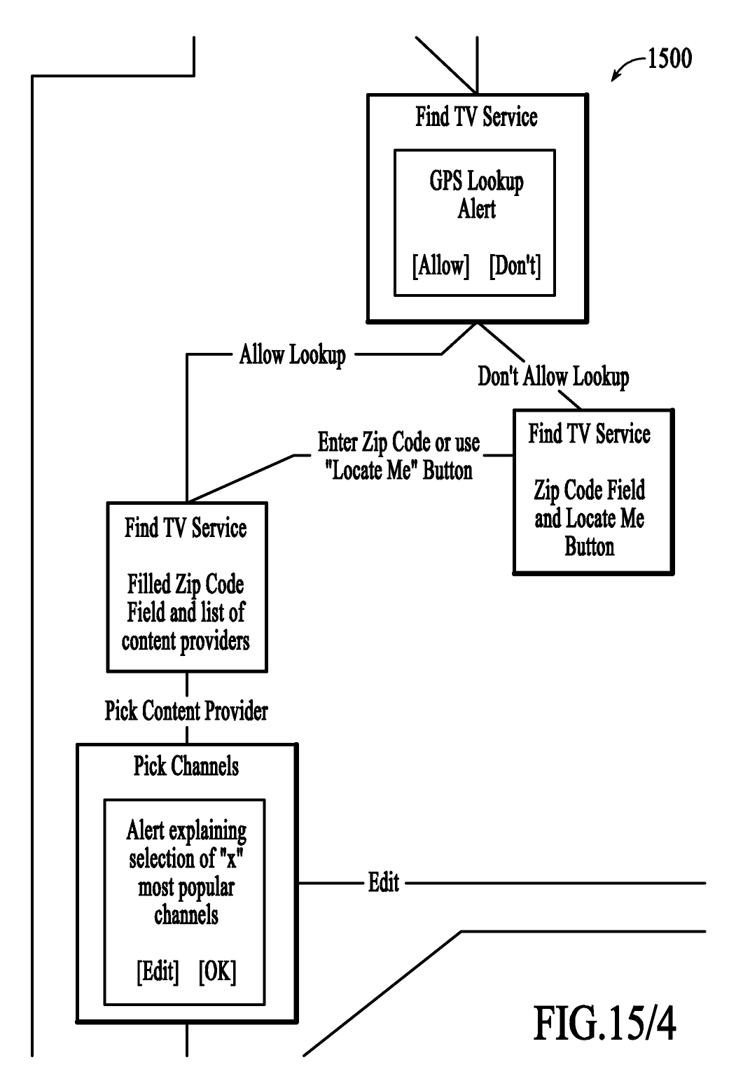

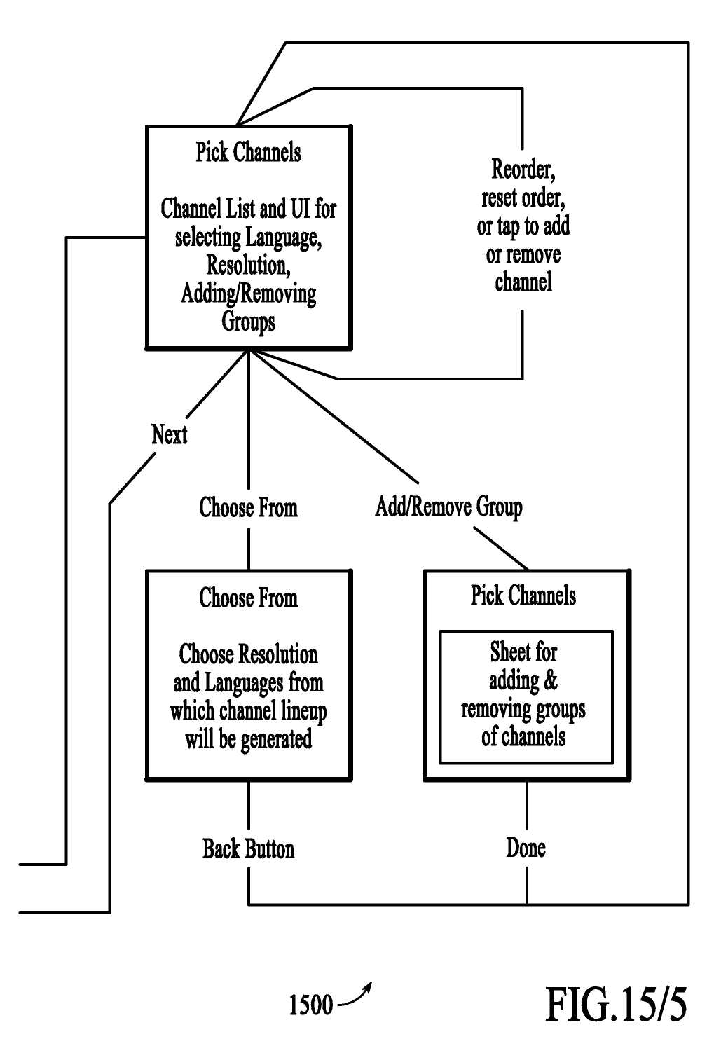

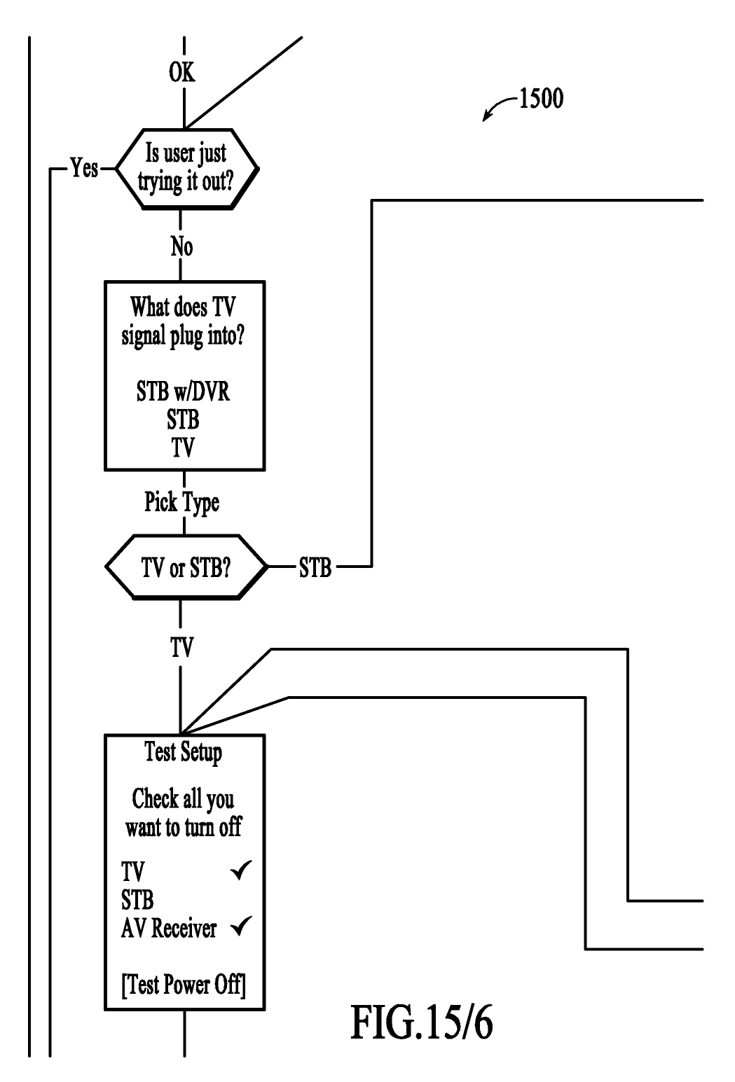

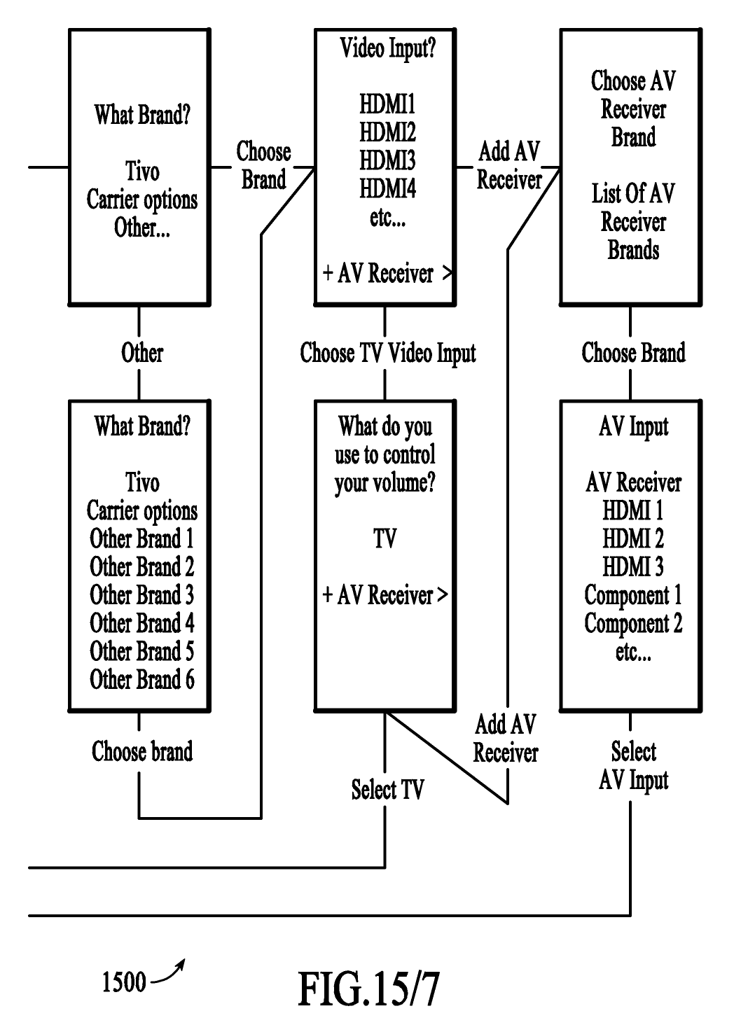

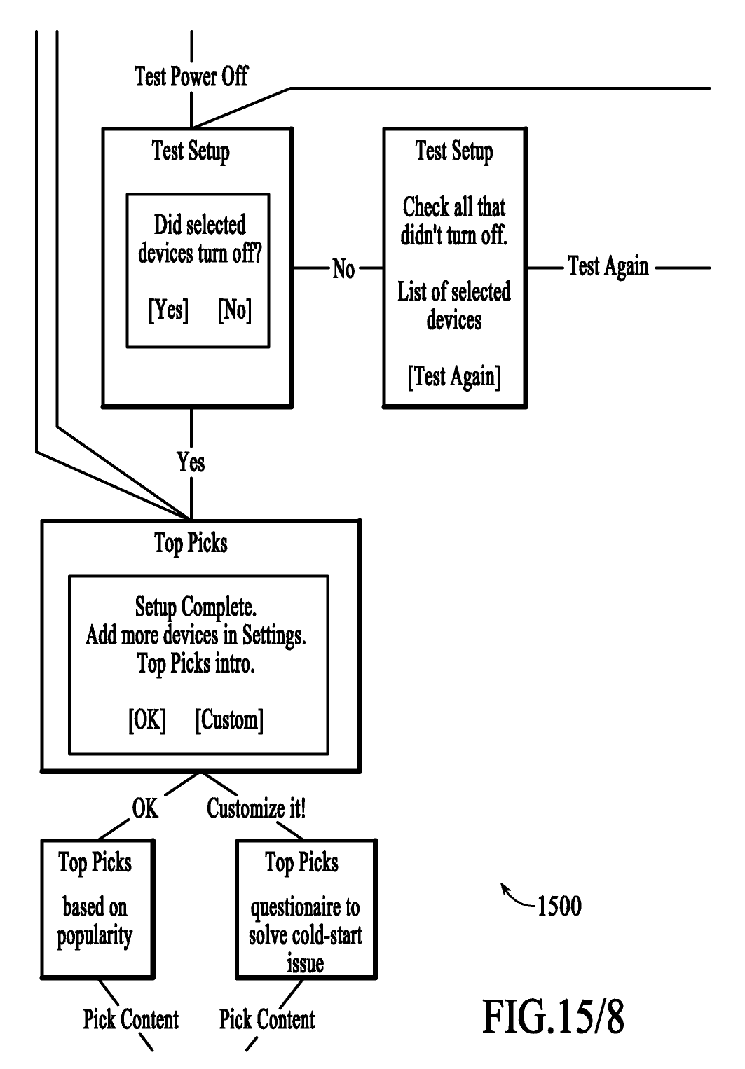

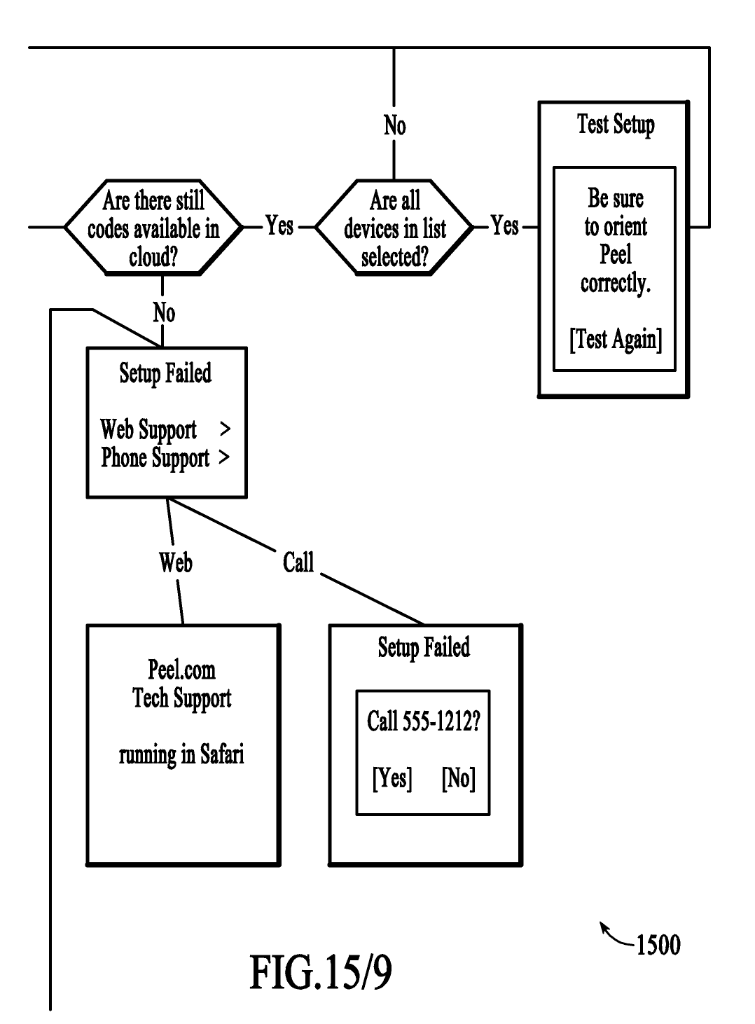

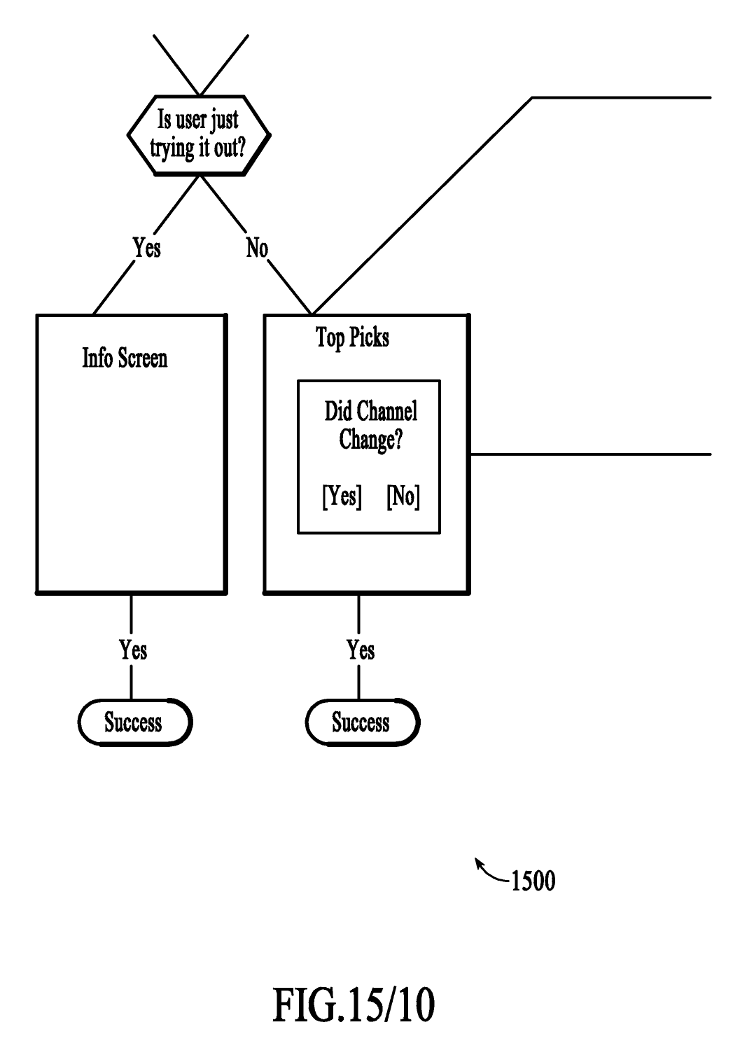

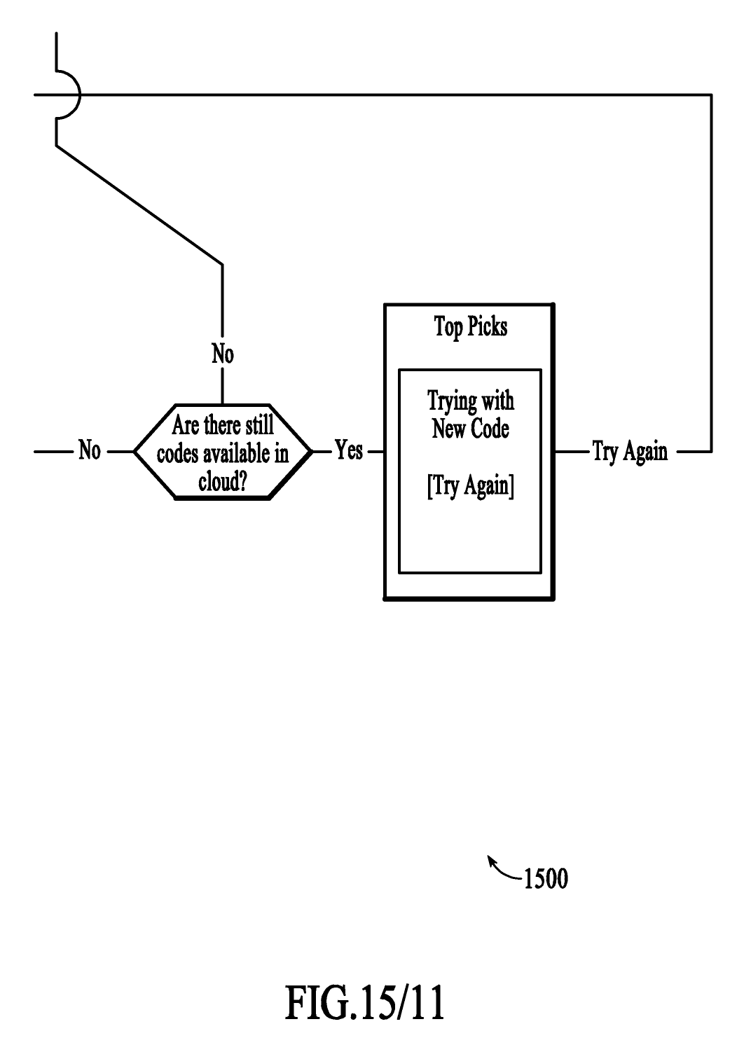

The user provides the configuration information when he sets the system up for the first time. FIG. 15 (collectively 15/1, 15/2 and 15/3) is a flow diagram 1500 for specifying and configuring the DBCS to interact with media components at a premise, under an embodiment. The device map database stores every user's media system configuration, and, as a consumer adds new devices to the configuration, the new device is added to that consumer's configuration database. The device setup information of a user's premise is transformed to a connection map and is stored in the device map database; furthermore, a local copy of this configuration database is stored in the IED.

As described above, consumers of media content are faced with the ever increasing dilemma of finding interesting content to watch from a variety of sources (e.g., broadcast TV, internet TV, satellite TV, DVD, VOD, etc.). As a solution, the DBCS of an embodiment comprises a personalized Content Recommendation System (CRS) to identify content that will be of interest to a specific user irrespective of its source and to provide the recommendations to the user in a personalized way. The provision of such a discovery mechanism has been shown to significantly increase consumer satisfaction and is rapidly becoming an essential tool for any form of content (e.g., retail, news, blogs, TV, movies, music, etc.) where there is significant number of alternatives to chose from.

The personalized CRS, also referred to herein as Serendipity, provides a set of recommendations that significantly enhance the user experience of the DBCS. Recommendations of the CRS take into account not only the personalized desires of an end user, but also the context in which the recommendation is made. Therefore, the CRS recommendations are both personalized and contextualized. For example, an individual is likely to want to watch different content at 3 pm on a Wednesday afternoon than the content that they will want to watch on Friday at 11 pm and this should be taken into account when making recommendations. Similarly, an individual's mood will influence the content that they wish to watch. The CRS evolves continuously as it receives and assimilate additional information about a consumer's viewing habits.

The CRS of an embodiment performs attribute matching. Consequently, it starts with little consumer behavior information, (the Cold Start problem), and the initial approach is based on matching consumer preferences for program attributes with the attributes of forthcoming shows. So, for example, the genre and channel on which a program is shown will be used to generate initial recommendations. Research on TV schedules shows that this will provide “safe” choices for the end user. These recommendations are combined with a random, but carefully selected, set of other choices to provide “serendipity”.

The CRS of an embodiment performs collaborative filtering. Good recommendations flow from accounting for user behavior as this enables the “wisdom of the crowds” to be used to tailor recommendations. As data is collected, recommendations based on matching similar users and similar program content are combined into the recommendation scheme. This combination of approaches provides better recommendations than either approach used alone.

The CRS of an embodiment provides context-based recommendations. Context-based recommendations are generated by weighting recommendations based on the time of the program being shown (e.g., horror shows are recommended more during the evening, etc.) and by providing access to the programs via genre (use as an initial surrogate for mood). As detailed viewing statistics are received, the CRS of an embodiment shifts the basis for the contextual recommendations from those purely based on metadata to recommendations based on contextual information extracted from user viewing habits.

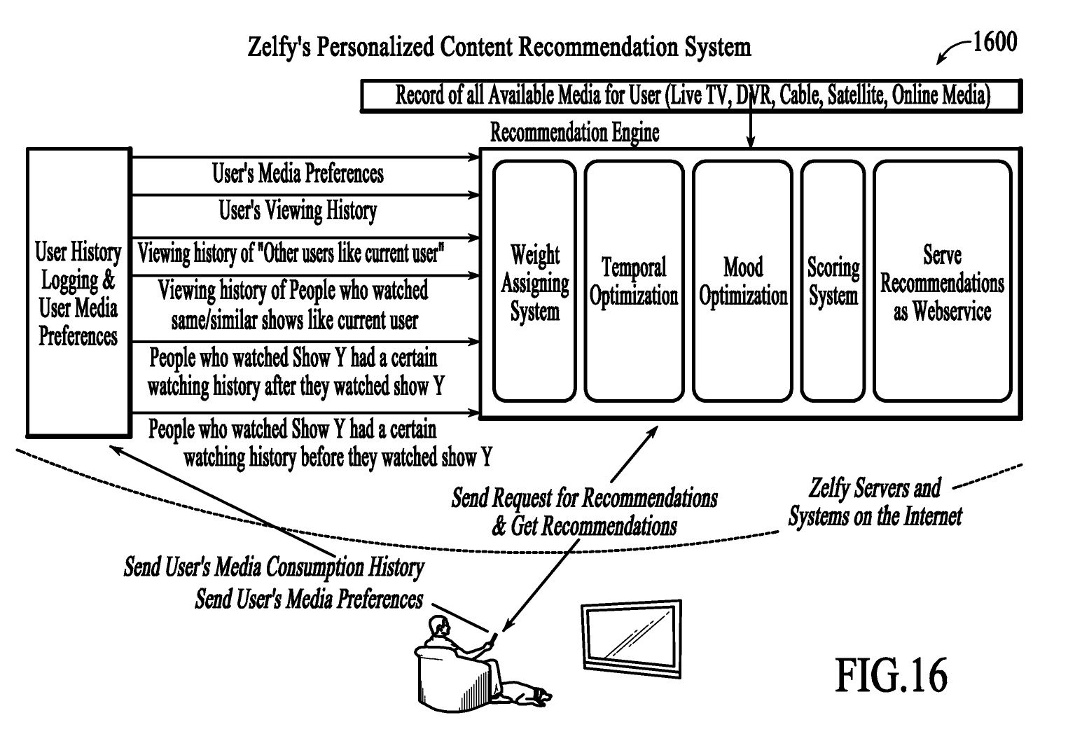

FIG. 16 is a block diagram 1600 for operation of the CRS, under an embodiment. Operation begins when a user opens the DBCS application on his IED. The DBCS application records local time. The DBCS application sends to the DBCS Recommendation System (CRS) running on the DBCS servers a request for a list of recommendations for the user. The DBCS application sends the local time and current mood to the CRS.

The CRS of an embodiment comprises a recommendation engine that includes a weight assigning system, temporal optimization component, mood optimization component, scoring system and webservice component to serve recommendations. The recommendation engine receives inputs including a record of all available media for a user, and inputs from user history logging and user media preferences component. The inputs to the CRS of an embodiment comprise one or more of the following, but the embodiment is not so limited: current local time of user; user media preferences, where the media preference comprise preferences of one or more subgroups including Language Preference, Media Quality Preference (e.g., Hi Definition Only, Standard Definition Only, etc.), Genre Preference (e.g., Action, Adventure, etc.), Channel Preference (e.g., NBC, ABC, Discovery, etc.), Source Preference (e.g., Online, Live TV, Cable, etc.); user viewing history; viewing history of users similar to the current user; viewing history of users that watched same/similar shows as the current user; succeeding viewing history of other users, after they watched a particular show; preceding viewing history of other users, before they watched a particular show; given the current local time, the list of all media available to the user.

Using the CRS inputs described above, the CRS generates a list of recommended content that is available for the user. The list of recommended content is presented to the user, and the user selects media content from the list. Using the IED interface, the user selects the content and starts enjoying the content. The user's selection is recorded and sent back to the User History Logger for subsequent use in the CRS.

Because well implemented “discovery mechanisms” are used more frequently than search mechanisms when both are provided on a website, the CRS, via presentation on the IED of an embodiment, presents a ‘Top Picks’ page of recommendations and not a search page. The CRS, via presentation on the IED, also leads with content ordered by genre (e.g., News, Comedy, etc.) in order to facilitate users selecting content. In order to reduce the amount of searching required to locate a desired program, the CRS, via presentation on the IED, lists content according to the likelihood (based on their previous viewing history) that the individual wishes to watch each program. Furthermore, the CRS, via presentation on the IED, lists all content that is viewable (and perhaps some that is not currently viewable using the current channel setup), to ensure that the user is not limited in the choices they make.

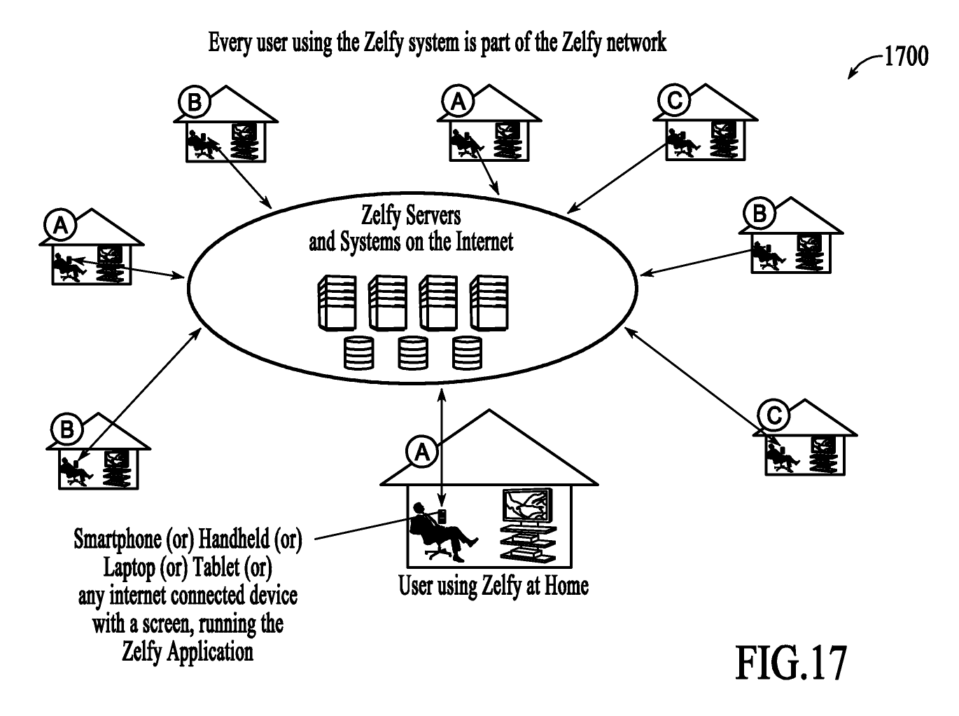

The DBCS uses the DBCS software or applications running on the IED and/or on remote servers to automatically form a social network (referred to herein as the DBCS Network) that includes all users of the DBCS system. As such, the DBCS enables social interactions around the DBCS Network such that DBCS users connect with other users, discover people with like interests, and communicate with other people. FIG. 17 is a block diagram 1700 of a social network formed among DBCS users, under an embodiment. The social network of this example includes friend groups A/B/C (e.g., all have similar taste in media content) joined via the DBCS.

The MDSC users can discover other people via the DBCS Network because every DBCS user is logically connected via the DBCS servers. When people are online at the same time, the DBCS can enable a first user to connect with other users that are watching the same show as the first user. Users can also pick a person on the DBCS Network and see what show(s) he/she watches. The DBCS enables two-way communication between users on the DBCS Networks.

The MDSC users can also discover other people via third party social networks. The DBCS couples or connects an DBCS user to the third party social networks (e.g., Facebook, Twitter, etc.) of which the user is a member. The couplings between the DBCS and the third party social networks make available to the user his/her social contacts in those networks, and two-way communication is enabled between the user and any person on the third party social networks.

The DBCS users who are connected via the DBCS Network and/or third party social networks, by virtue of the DBCS, can recommend shows to each other, discover like-minded users on the network and watch the same shows that they might be watching, discover users who are watching the same show and become friends, discuss shows live while the shows are in progress, and join a group of users with similar taste in media content.

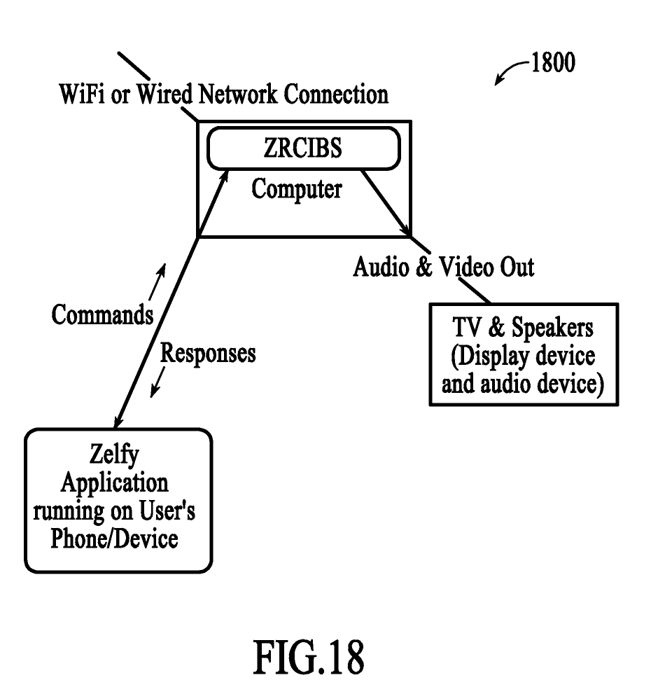

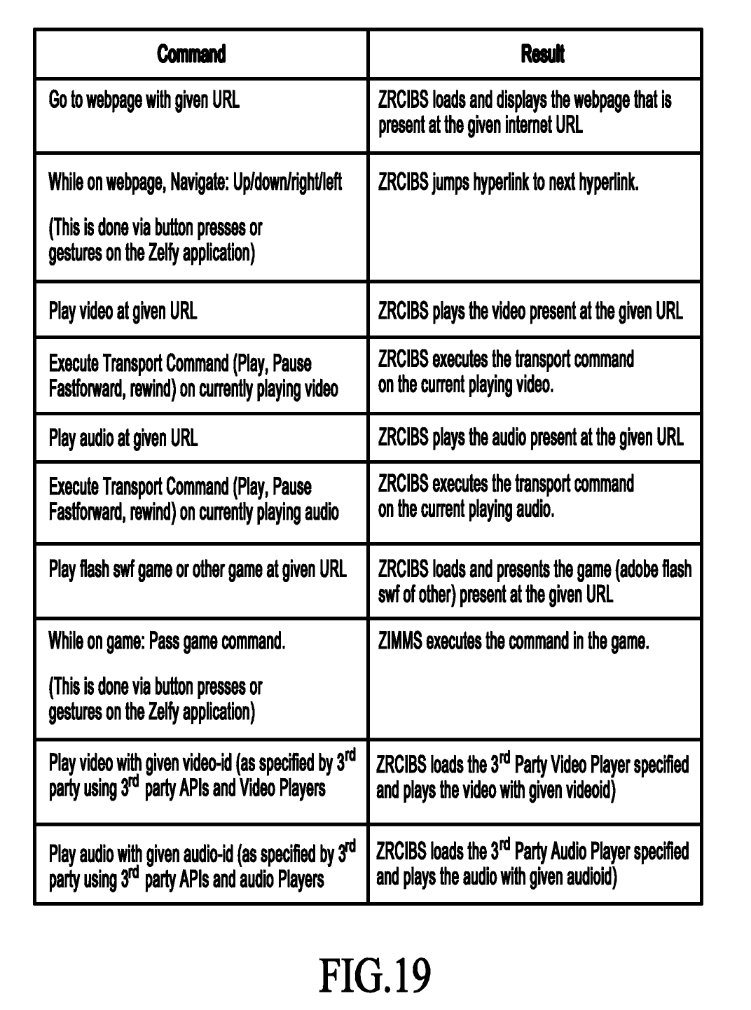

The DBCS of an embodiment comprises remote-controlled internet browser software (RCIBS). The RCIBS is a remote controllable internet browser optimized for internet-media consumption. FIG. 18 is a block diagram 1800 of a home network comprising a computer hosting the RCIBS and the IED, under an embodiment. The RCIBS is deployed on a computer that has video, audio and internet capabilities and is connected to the home network of the user. The IED hosting the DBCS application is also coupled to the home network. The IED transmits commands to the RCIBS and receives responses from the RCIBS; the commands are received and executed by RCIBS. FIG. 19 is a table of commands generated by the IED and the resulting action or operation by the RCIBS in response to the command, under an embodiment.

Embodiments described herein comprise a system including a media control network coupled to the internet via a local network of a premise. The system of an embodiment includes a media management application running on an internet-enabled device (IED) and controlling media devices at the premise via the media control network. The system of an embodiment includes a content recommendation system (CRS) coupled to the media management application, wherein the CRS learns media preferences from user behavior, generates from a plurality of disparate media sources media choices corresponding to the media preferences, and presents the media choices on the IED, wherein the media management application automatically controls delivery of selected media content and selects and controls the media devices that deliver the selected media content according to a media type of the selected media content.

Embodiments described herein comprise a system including a media control network at a premise, the media control network coupled to a local network of the premise and to a public network. The system of an embodiment includes a media management application running on an internet-enabled device (IED) and coupled to the media control network, wherein the media management application controls a plurality of media devices at the premise. The system of an embodiment includes a content recommendation system (CRS) coupled to the media management application, wherein the CRS receives and aggregates media content from a plurality of media sources that are disparate sources, learns media preferences from user behavior, generates from the aggregated media content media content choices corresponding to the media preferences, and presents the media content choices on the IED via the media management application, wherein, in response to a user selection on the IED of selected media content, the media management application automatically controls delivery of the selected media content and selects and controls the media devices needed to deliver the selected media content according to a media type of the selected media content.

The IED of an embodiment includes a smartphone.

The IED of an embodiment includes a tablet computer.

The media management application of an embodiment generates and presents via the IED contextual media device controls according to a media type of the selected media content, wherein the media device controls are enabled through at least one of gestures on a touchscreen of the IED and gestures made with the IED.

The system of an embodiment comprises a first social network formed via couplings between the media management application of the user and at least one other media management application of at least one other user, wherein the at least one other user has a IED that includes the at least one other media management application.

The system of an embodiment comprises a second social network formed via a coupling between the media management application and a third party social network, wherein access to a plurality of social contacts of the user on the third party social network are available to the user via the media management component and the IED.

The CRS of an embodiment learns the media preferences from a viewing history of the user.

The CRS of an embodiment learns the media preferences from a viewing history of at least one other user like the user.

The CRS of an embodiment learns the media preferences from a viewing history of at least one other user that watched at least one of identical media content and similar media content to that viewed by the user.

The CRS of an embodiment learns the media preferences from a succeeding viewing history of the at least one other user after the at least one other user watched specified media content.

The CRS of an embodiment learns the media preferences from a preceding viewing history of the at least one other user before the at least one other user watched specified media content.

The CRS of an embodiment learns the media preferences from all media content available to the user at a current time.

The CRS of an embodiment learns the media preferences from at least one of viewing history of the user, viewing history of at least one other user like the user, viewing history of at least one other user that watched at least one of identical media content and similar media content to that viewed by the user, succeeding viewing history of the at least one other user after the at least one other user watched specified media content, preceding viewing history of the at least one other user before the at least one other user watched specified media content, and all media content available to the user at a current time.

The media preferences of an embodiment comprise a language preference.

The media preferences of an embodiment comprise a media quality preference.

The media preferences of an embodiment comprise a genre preference.

The media preferences of an embodiment comprise a channel preference.

The media preferences of an embodiment comprise a source preference.

The media preferences of an embodiment comprise at least one of a language preference, a media quality preference, a genre preference, a channel preference, and a source preference.

The CRS of an embodiment controls the presentation of the media content choices on the IED to include a “Top Picks” page of recommendations instead of a search page.

The CRS of an embodiment controls the presentation of the media content choices on the IED to include content ordered by genre.

The CRS of an embodiment controls the presentation of the media content choices on the IED to include content ordered according to a probability the user will select the media content.

The CRS of an embodiment controls the presentation of the media content choices on the IED to include all media content that is viewable.

The media control network of an embodiment comprises a hub coupled to the local network of the premise and to the public network.

The media control network of an embodiment comprises at least one node, wherein a number of nodes at the premise corresponds to a number of televisions at the premise, wherein the at least one node is registered with the hub and receives commands from the hub via a wireless coupling.

The at least one node of an embodiment receives radio frequency (RF) commands from the hub, translates the RF commands into infrared signals (IR) that correspond to the selected media devices needed to deliver the selected media content.

The system of an embodiment comprises an infrared (IR) database that includes a plurality of IR codes corresponding to the plurality of media devices, wherein the at least one node uses the IR codes for the translation of the RF commands into IR signals.

Each IR code of an embodiment is maintained in a universal control (UES) format, the UES format representing a frequency and mark-space timing of IR pulses as a series of numbers.

The system of an embodiment comprises internet-based or network-based distribution of IR codes, wherein each IR code is maintained in an uncompressed universal control (UES) format. The UES format represents a frequency and mark-space timing of IR pulses as a series of numbers.

The system of an embodiment comprises a device map database that is a logical representation of the plurality of media devices at the premise and a coupling between the plurality of media devices.

The system of an embodiment comprises a remote-controlled internet browser (RCIB) running on a device coupled to the local network, wherein the media management application communicates with and controls the RCIB.

Embodiments described herein comprise a computing method running on a processor, the method coupling a media control network to the internet via a local network of a premise. The method of an embodiment includes controlling media devices at the premise via a media management application running on an internet-enabled device (IED) and the media control network. The method of an embodiment comprises learning media preferences from user behavior. The method of an embodiment comprises generating from a plurality of disparate media sources media choices corresponding to the media preferences. The method of an embodiment comprises presenting the media choices on the IED. The method of an embodiment comprises automatically controlling delivery of selected media content and selecting and controlling the media devices that deliver the selected media content according to a media type of the selected media content.

The method of an embodiment comprises generating and presenting via the IED contextual media device controls according to a media type of the selected media content, wherein the media device controls are enabled through at least one of gestures on a touchscreen of the IED and gestures made with the IED.

The method of an embodiment comprises forming a first social network via couplings between the media management application of the user and at least one other media management application of at least one other user, wherein the at least one other user has a IED that includes the at least one other media management application.

The method of an embodiment comprises forming a second social network via a couplings between the media management application and a third party social network, wherein access to a plurality of social contacts of the user on the third party social network are available to the user via the media management component and the IED.

The method of an embodiment comprises learning the media preferences from at least one of viewing history of the user, viewing history of at least one other user like the user, viewing history of at least one other user that watched at least one of identical media content and similar media content to that viewed by the user, succeeding viewing history of the at least one other user after the at least one other user watched specified media content, preceding viewing history of the at least one other user before the at least one other user watched specified media content, and all media content available to the user at a current time.

The method of an embodiment comprises controlling the presentation of the media content choices on the IED to include a “Top Picks” page of recommendations instead of a search page.

The method of an embodiment comprises controlling the presentation of the media content choices on the IED to include content ordered by genre.

The method of an embodiment comprises controlling the presentation of the media content choices on the IED to include content ordered according to a probability the user will select the media content.

The method of an embodiment comprises controlling the presentation of the media content choices on the IED to include all media content that is viewable.

The method of an embodiment comprises providing a node for each television at the premise.

The method of an embodiment comprises registering each node with the hub.

The method of an embodiment comprises receiving radio frequency (RF) commands from the hub, and translating the RF commands into infrared signals (IR) that correspond to the selected media devices needed to deliver the selected media content.

The method of an embodiment comprises providing an infrared (IR) database that includes a plurality of IR codes corresponding to the plurality of media devices.

The method of an embodiment comprises maintaining each IR code in a universal control (UES) format, the UES format representing a frequency and mark-space timing of IR pulses as a series of numbers.

The method of an embodiment comprises distributing the IR codes via the internet, wherein each IR code is maintained in an uncompressed universal control (UES) format. The UES format represents a frequency and mark-space timing of IR pulses as a series of numbers.

The method of an embodiment comprises generating and maintaining a device map database that is a logical representation of the plurality of media devices at the premise and a coupling between the plurality of media devices.

The method of an embodiment comprises accessing a public network via the IED using a remote-controlled internet browser (RCIB) running on a device coupled to the local network.

In addition to premise media content navigation and control, the DBCS can generally be used for premise automation and control. The zHub and zNode communicate with each other using a general purpose radio that is compatible with other communication protocols and devices (e.g., Zigbee, etc.), so the IED can therefore be used to control other devices in the home, for example, home appliances, lamps, refrigerators to name a few.

The DBCS of an embodiment enables a payment platform on the IED. The payment platform includes an integrated payment system within the remote control from which payments can be made to purchase media content or other items and/or services. For example, users can watch a movie and then purchase the DVD of that movie from the IED. As another example, users can pay for services from the IED (e.g., Netflix, Cinema Now, Amazon Video On Demand, etc.).

The DBCS of an embodiment enables a surrounding environment-aware entertainment experience optimization using sensors coupled or connected to the DBCS components. For example, sensors in the area or environment in which media are consumed measure parameters or characteristics of the environment (e.g., noise, temperature, lighting, etc.). Depending on the measured parameters, the media devices (e.g., TV, home theater, etc.) can be adjusted (e.g., volume, brightness, etc.) in order to optimize the surrounding environment for the entertainment experience.

The DBCS of an embodiment enables control via the IED of other radio-controlled devices at the premise. Some combination of the DBCS components of an embodiment (e.g., IED, zNode, zHub, etc.) comprise software and a hardware that listen on WiFi and transmit radio signals in the frequency of a remote-controlled or radio-controlled device. The MDSC maps the user command received via the IED to WiFi signals that are communicated to the hardware. The hardware converts the WiFi signals to radio signals corresponding to the radio-controlled device.

The DBCS of an embodiment enables a messaging platform for remote controls that supports two way communication (e.g., system to user and user to system communication). A third party with authorization can send messages to all remote controls, a specific group of remote controls, and/or a specific remote control located in the premise. The messages can be one or more of multimedia messages, alerts, information, questions, and/or advertisements, to name a few. The messages can include, for example, interaction screens with which the user can communicate in real time with the system transmitting the message.

The DBCS of an embodiment enables browsing web-based merchant stores on TV. The DBCS also enables purchases from web-based merchants via the TV.

The DBCS of an embodiment enables the dynamic presentation of advertisements on the IED. The advertisements include stand alone advertisements as well as companion advertisements that appear and play in synchronization with an advertisement currently displayed on the user's TV. The advertisements can be actionable in that they enable the user to enroll in a service, buy a product or service, and/or request/receive additional information.

The DBCS of an embodiment enables the user to preview media content on the IED before he/she watches the content on TV.

The DBCS of an embodiment enables via the IED smart “age ratings” management by enabling the IED as a smart remote control that automatically knows what show ratings (e.g., G, PG, PG-13, R, NC-17, etc.) are safe for viewing by people of a particular age group. Depending on the age on the user profile, the DBCS automatically hides or presents content. The IED of an embodiment includes multiple user profiles, and controls display of the media content based on the identity of the individual currently using the IED.

The DBCS of an embodiment enables remote control analytics by gathering data on user behavior in entertainment consumption, live audience measurement, live advertisement measurement, and geographical and demographical targeting.

The DBCS of an embodiment enables a cloud-based personal media controller and on-demand media delivery system. The DBCS enables users to watch live programming and store a copy of content being watched to their account on the DBCS. The DBCS enables users to schedule recordings like a DVR, but instead of recording the show to a hardware device in the user's home, the recording is stored in the users account on the DBCS. Thus, consumers can use the DBCS as their virtual DVR or virtual personal video recorder.

The DBCS of an embodiment enables a user to schedule alerts/alarms in their IED. When a scheduled program starts, the users are reminded of it by alerts/alarms in the IED. Users can also choose to receive a reminder some period of time before start of the show. The alert/alarm times can be adjusted at will by the user. If the user is away from the premise and cannot watch the show, he can choose to perform a remote recording of the show, using his IED.

As described above, computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof The computer network may include one of more LANs, WANs, Internets, and computers. The computers may serve as servers, clients, or a combination thereof

The DBCS can be a component of a single system, multiple systems, and/or geographically separate systems. The DBCS can also be a subcomponent or subsystem of a single system, multiple systems, and/or geographically separate systems. The DBCS can be coupled to one or more other components (not shown) of a host system or a system coupled to the host system.

One or more components of the DBCS and/or a corresponding system or application to which the DBCS is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the DBCS can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the DBCS and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the DBCS and corresponding systems and methods include: microcontrollers with memory (such as electronically erasable programmable read only memory (EEPROM)), embedded microprocessors, firmware, software, etc. Furthermore, aspects of the DBCS and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the DBCS and corresponding systems and methods is not intended to be exhaustive or to limit the systems and methods to the precise forms disclosed. While specific embodiments of, and examples for, the DBCS and corresponding systems and methods are described herein for illustrative purposes, various equivalent modifications are possible within the scope of the systems and methods, as those skilled in the relevant art will recognize The teachings of the DBCS and corresponding systems and methods provided herein can be applied to other systems and methods, not only for the systems and methods described above.

The elements and acts of the various embodiments described above can be combined to provide further embodiments. These and other changes can be made to the DBCS and corresponding systems and methods in light of the above detailed description.

In general, in the following claims, the terms used should not be construed to limit the DBCS and corresponding systems and methods to the specific embodiments disclosed in the specification and the claims, but should be construed to include all systems that operate under the claims. Accordingly, the DBCS and corresponding systems and methods is not limited by the disclosure, but instead the scope is to be determined entirely by the claims.

While certain aspects of the DBCS and corresponding systems and methods are presented below in certain claim forms, the inventors contemplate the various aspects of the DBCS and corresponding systems and methods in any number of claim forms. Accordingly, the inventors reserve the right to add additional claims after filing the application to pursue such additional claim forms for other aspects of the DBCS and corresponding systems and methods.

What is claimed is:

1. A system comprising:
a media control network coupled to the internet via a local network of a premise;
a media management application running on an internet-enabled device (IED) and controlling media devices at the premise via the media control network; and
a content recommendation system (CRS) coupled to the media management application, wherein the CRS learns media preferences from user behavior, generates from a plurality of disparate media sources media choices corresponding to the media preferences, and presents the media choices on the IED, wherein the media management application automatically controls delivery of selected media content and selects and controls the media devices that deliver the selected media content according to a media type of the selected media content.

2. A system comprising:
a media control network at a premise, the media control network coupled to a local network of the premise and to a public network;
a media management application running on an internet-enabled device (IED) and coupled to the media control network, wherein the media management application controls a plurality of media devices at the premise; and
a content recommendation system (CRS) coupled to the media management application, wherein the CRS receives and aggregates media content from a plurality of media sources that are disparate sources, learns media preferences from user behavior, generates from the aggregated media content media content choices corresponding to the media preferences, and presents the media content choices on the IED via the media management application, wherein, in response to a user selection on the IED of selected media content, the media management application automatically controls delivery of the selected media content and selects and controls the media devices needed to deliver the selected media content according to a media type of the selected media content.

3. The system of claim 2, wherein the IED includes a smartphone.

4. The system of claim 2, wherein the IED includes a tablet computer.

5. The system of claim 2, wherein the media management application generates and presents via the IED contextual media device controls according to a media type of the selected media content, wherein the media device controls are enabled through at least one of gestures on a touchscreen of the IED and gestures made with the IED.

6. The system of claim 2, comprising a first social network formed via couplings between the media management application of the user and at least one other media management application of at least one other user, wherein the at least one other user has a IED that includes the at least one other media management application.

7. The system of claim 2, comprising a second social network formed via a coupling between the media management application and a third party social network, wherein access to a plurality of social contacts of the user on the third party social network are available to the user via the media management component and the IED.

8. The system of claim 2, wherein the CRS learns the media preferences from at least one of viewing history of the user, viewing history of at least one other user like the user, viewing history of at least one other user that watched at least one of identical media content and similar media content to that viewed by the user, succeeding viewing history of the at least one other user after the at least one other user watched specified media content, preceding viewing history of the at least one other user before the at least one other user watched specified media content, and all media content available to the user at a current time.

9. The system of claim 2, wherein the media preferences comprise at least one of a language preference, a media quality preference, a genre preference, a channel preference, and a source preference.

10. The system of claim 2, wherein the CRS controls the presentation of the media content choices on the IED to include a “Top Picks” page of recommendations instead of a search page.

11. The system of claim 2, wherein the CRS controls the presentation of the media content choices on the IED to include content ordered by genre.

12. The system of claim 2, wherein the CRS controls the presentation of the media content choices on the IED to include content ordered according to a probability the user will select the media content.

13. The system of claim 2, wherein the CRS controls the presentation of the media content choices on the IED to include all media content that is viewable.

14. The system of claim 2, wherein the media control network comprises a hub coupled to the local network of the premise and to the public network.

15. The system of claim 14, wherein the media control network comprises at least one node, wherein a number of nodes at the premise corresponds to a number of televisions at the premise, wherein the at least one node is registered with the hub and receives commands from the hub via a wireless coupling.

16. The system of claim 15, wherein the at least one node receives radio frequency (RF) commands from the hub, translates the RF commands into infrared signals (IR) that correspond to the selected media devices needed to deliver the selected media content.

17. The system of claim 16, comprising an infrared (IR) database that includes a plurality of IR codes corresponding to the plurality of media devices, wherein the at least one node uses the IR codes for the translation of the RF commands into IR signals.

18. The system of claim 17, wherein each IR code is maintained in a universal control (UES) format, the UES format representing a frequency and mark-space timing of IR pulses as a series of numbers, wherein each IR code is distributed to at least one of the media control network and the media management application via the internet.

19. The system of claim 2, comprising a device map database that is a logical representation of the plurality of media devices at the premise and a coupling between the plurality of media devices.

20. The system of claim 2, comprising a remote-controlled internet browser (RCIB) running on a device coupled to the local network, wherein the media management application communicates with and controls the RCIB.
